(19) United States
(12) Patent Application Publication
(10) Pub. No.: US 2026/0281073 A1
(43) Pub. Date: Sep. 17, 2026

(54) SYSTEM

(71) Applicant: SoftBank Group Corp., Tokyo (JP)

(72) Inventor: Shohei HASHIBA, Tokyo (JP)

(73) Assignee: SoftBank Group Corp., Tokyo (JP)

(21) Appl. No.: 19/547,688

(22) Filed: Feb. 24, 2026

Related U.S. Application Data
(60) Provisional application No. 63/769,904, filed on Mar. 11, 2025.

(51) Int. Cl. H04L 51/224; G06F 40/151; G06F 40/284; G06N 3/045; G06N 3/0499

(52) U.S. Cl. CPC H04L 51/224; G06F 40/151; G06F 40/284; G06N 3/045; G06N 3/0499

(57) ABSTRACT

A system includes a processor that is configured to acquire messages from a plurality of different communication applications, to analyze acquired messages using natural language processing to evaluate an urgency and an importance of each message based on content of the message, to generate a notification directed to a user for a message that is evaluated as having high urgency and high importance, and to generate a summary for a message that is evaluated as having low urgency and low importance and to provide the summary for later review by the user.

### CROSS-REFERENCE TO RELATED APPLICATION

This application claims the benefit of U.S. Provisional Application No. 63/769,904, filed on Mar. 11, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, users have increasingly relied on multiple heterogeneous communication applications, such as email services, chat applications, and business messaging platforms, to conduct daily business and personal activities. As a result, users are exposed to a large volume and high frequency of incoming messages distributed across different platforms. Conventional systems generally present messages in chronological order within each individual application and lack integrated control of urgency and importance across platforms. Consequently, the user is frequently interrupted by non-urgent or low-importance notifications, which leads to decreased work efficiency, difficulty in concentrating on essential tasks, and increased cognitive load and stress. Furthermore, conventional notification mechanisms usually do not adapt to user-specific preferences or past behavior, and do not provide a consolidated summary of low-priority information that can be reviewed efficiently at a convenient time. Therefore, there is a need for a system capable of centrally acquiring messages from multiple communication applications, automatically evaluating the urgency and importance of each message, selectively notifying the user only of messages that require immediate attention, and providing concise summaries of low-priority messages for later review, while taking into account user settings and past feedback to improve precision over time.

### SUMMARY

In order to solve the above-described problems, according to one aspect of the present invention, there is provided a system comprising a processor, wherein the processor is configured to acquire messages from a plurality of different communication applications, analyze acquired messages using natural language processing to evaluate an urgency and an importance of each message based on content of the message, generate a notification directed to a user for a message that is evaluated as having high urgency and high importance, and generate a summary for a message that is evaluated as having low urgency and low importance and provide the summary for later review by the user. In an embodiment, the processor is configured to periodically acquire the messages by using respective application programming interfaces of the communication applications, to tokenize text of each acquired message and perform keyword extraction and context analysis on the text, to transmit a pop-up notification or an audio alert to a device of the user for selected high-priority messages, and to generate the summary by summarizing a plurality of messages and extracting important points into a concise summary. In another embodiment, the processor is configured to analyze the content of each message by using a machine learning algorithm to evaluate the urgency and the importance of the message and to improve analysis accuracy based on past feedback from the user, to customize a notification method according to settings of the user, and to provide a generated summary to the user via a dedicated dashboard or via email. By these means, the system can reduce unnecessary interruptions from low-priority messages, allow the user to focus on important information, and support efficient review of aggregated low-priority information at an appropriate time.

The term “system” refers to an arrangement of one or more hardware devices and software components that cooperate to perform the functions recited in the claims, including acquiring, analyzing, notifying, and summarizing messages.

The term “processor” refers to one or more hardware processing units, such as a central processing unit (CPU), a microprocessor, a digital signal processor (DSP), a graphics processing unit (GPU), or any combination thereof, configured to execute computer-readable instructions to perform the functions described in the claims.

The term “configured to” refers to being programmed, arranged, adapted, or otherwise equipped, by hardware, software, firmware, or any combination thereof, to perform the specified function or operation.

The term “message” refers to an individual unit of electronic communication transmitted via a communication application, including but not limited to an email, a chat message, an instant message, a post, a notification, or a similar textual or multimedia communication.

The term “communication application” refers to any software or service that enables users to send, receive, or manage electronic messages, including but not limited to email clients, webmail services, chat or instant messaging applications, collaboration tools, and business messaging platforms.

The term “acquire” refers to obtaining, receiving, retrieving, or collecting data, such as messages, from one or more external or internal sources via networks, application programming interfaces, protocols, or other communication mechanisms.

The term “application programming interface” refers to an interface, such as a set of functions, procedures, endpoints, or protocols, provided by a software service or platform to allow other software components to programmatically access, send, or retrieve data, including messages.

The term “natural language processing” refers to a set of computational methods and algorithms for processing, analyzing, and understanding human language data, including operations such as tokenization, morphological analysis, keyword extraction, context analysis, classification, and related techniques.

The term “urgency” refers to a degree or level indicating how quickly a message requires user attention or response, which may be classified into categories such as high, medium, or low based on the content and context of the message.

The term “importance” refers to a degree or level indicating the significance, relevance, or impact of a message to the user's tasks or objectives, which may be classified into categories such as high, medium, or low based on the content and context of the message.

The term “content of the message” refers to the information contained in a message, including text, metadata such as subject lines and timestamps, and optionally attachments or embedded data, that are used by the processor to evaluate urgency and importance.

The term “notification” refers to an output presented to the user, via a device, that indicates the occurrence, availability, or priority of one or more messages, and that may include visual, auditory, tactile, or other sensory elements.

The term “pop-up notification” refers to a visual notification element that appears on a display of the user's device, typically overlaying or appearing on top of existing content, to alert the user to a message or event.

The term “audio alert” refers to a sound, tone, voice output, or other audible signal generated by a device to notify the user of a message or event.

The term “summary” refers to a condensed representation of one or more messages, in which key points, important information, or essential elements are extracted and presented in a shorter form than the original messages.

The term “summarizing” refers to generating a summary by extracting, condensing, or reorganizing content from one or more messages to produce a shorter representation that preserves important information.

The term “important points” refers to key items of information within one or more messages that are determined to be notable, relevant, or significant for the user, such as decisions, deadlines, action items, or main topics.

The term “concise summary” refers to a summary that presents important points in a brief, compact form with reduced redundancy and unnecessary detail relative to the original messages.

The term “machine learning algorithm” refers to a computational method or model that can learn patterns or relationships from data, including training on historical messages and user feedback, and that can output predictions or classifications, such as urgency or importance of new messages.

The term “past feedback” refers to information provided explicitly or implicitly by the user regarding previous messages or notifications, including actions such as marking a message as important or not important, adjusting notification settings, or interacting with notifications, which is used to improve analysis accuracy.

The term “user settings” refers to configuration information specified by the user or on behalf of the user, including preferences related to notification methods, notification timing, quiet hours, priority thresholds, communication channels, and presentation of summaries. The term “notification method” refers to a mode or channel by which a notification is delivered to the user, including but not limited to pop-up notifications, audio alerts, email notifications, push notifications, or in-application alerts.

The term “user device” refers to any electronic device operated by or associated with the user, including but not limited to a smartphone, tablet, laptop computer, desktop computer, wearable device, or other terminal capable of receiving and presenting notifications and summaries.

The term “dedicated dashboard” refers to a graphical user interface or web-based or application-based screen provided by the system for the user to view summaries, message lists, priorities, and related information in an integrated manner.

The term “email” refers to an electronic mail message transmitted via an email server or service using standard or proprietary protocols, including but not limited to SMTP, POP3, or IMAP.

The term “business messaging platform” refers to a communication platform designed primarily for organizational or enterprise use, enabling messaging, collaboration, or notification among members of a company or project team.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

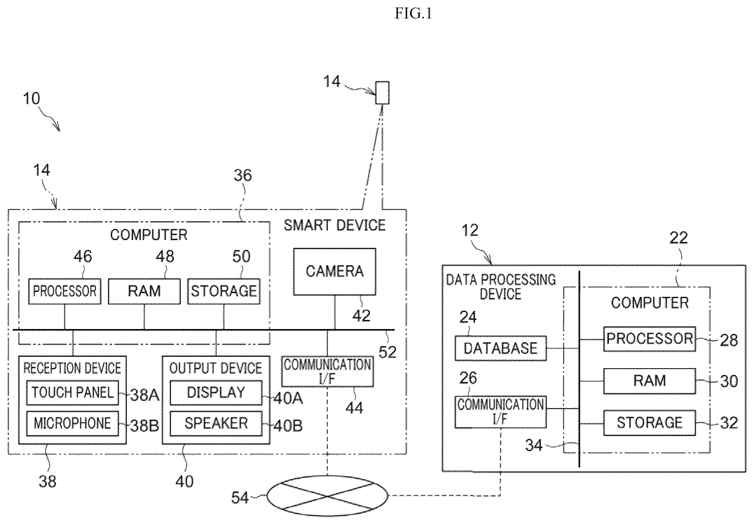

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

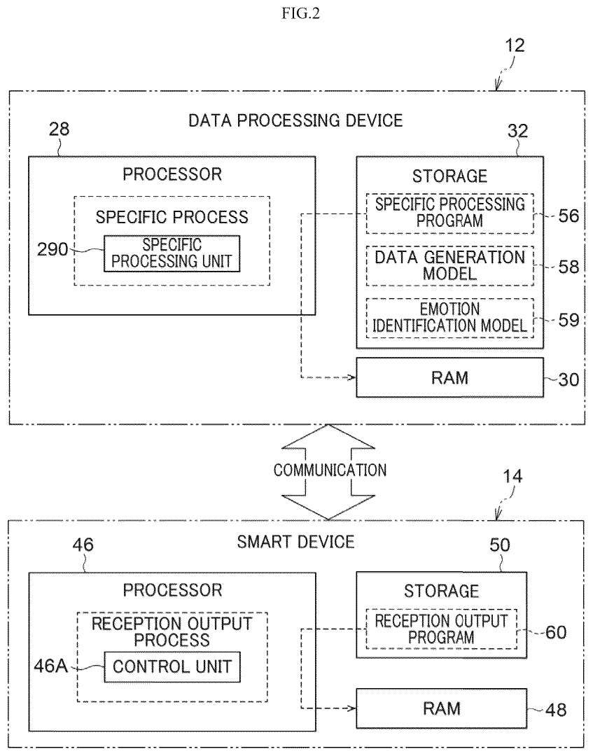

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional message management techniques that integrate electronic mail, chat, and other communication channels typically rely on fixed rule sets or shallow keyword filters implemented in software applications. Such approaches suffer from several technical problems in the field of computer technology.

First, existing systems treat heterogeneous message streams as uniform data without sufficiently leveraging structured, machine-readable metadata and context. As a result, the underlying computing platforms must process a continuous flow of notifications at the same priority level. This leads to excessive and redundant interrupt events at user terminals, which increases interrupt handling overhead in the operating system and application layers, degrades scheduling efficiency of processor resources, and reduces cache locality due to frequent context switching.

Second, conventional systems do not provide a robust, machine-level mechanism for dynamically adapting notification and summarization behavior based on user-specific patterns. Even when user preferences are nominally supported, they are usually stored as static configuration parameters and not fed back into any learning or inference pipeline. Consequently, the processor repeatedly executes non-optimal notification routines and summarization routines, resulting in wasted computational cycles on low-value or mis-prioritized messages and increasing input/output operations between server and terminal. Third, prior approaches that employ natural language processing or machine learning typically apply a single model in isolation and do not coordinate deterministic preprocessing, learned classification models, and generative artificial intelligence models through structured prompt sentences and feedback loops. Without such coordination, the system cannot efficiently exploit the complementary strengths of different models, and therefore cannot reduce the computational burden associated with misclassifications, re-processing of messages, and manual corrections by the user. This leads to increased memory usage for message states, duplicated processing in background tasks, and inefficiencies in the use of network bandwidth between server, external AI services, and user terminals.

Fourth, conventional summarization mechanisms often summarize messages in a coarse-grained manner without task-oriented extraction policies. The generated summaries tend to be poorly structured from the perspective of a computing workflow and cannot be easily indexed, filtered, or reused in downstream processes. This limits the computer's ability to treat summaries as structured data, which in turn reduces the efficiency of search, retrieval, and automated routing algorithms. The absence of fine-grained, machine-usable summary data causes additional processing load when the user or a downstream system attempts to recover actionable items from low-priority messages.

Accordingly, there is a need in computer technology for an improved message processing system that technically restructures the processing pipeline on a server and a user terminal. Such a system should (i) normalize and tokenize message content in a machine-optimized form, (ii) coordinate a natural language processing unit, a learned classification model, and a generative AI model through explicit prompt sentences and structured input/output formats, (iii) continuously adapt model behavior based on user operation history, and (iv) allocate messages into distinct processing queues that are handled by tailored notification and summarization routines. By doing so, the system should reduce unnecessary notification events, reduce redundant computations, and improve the efficiency of computing resources in handling multi-channel message streams.

The specific processing by the specific processing unit 290 of the data processing device 12 in Example 1 is realized by the following means.

The present invention provides a server comprising a processor configured to implement a message acquisition unit that acquires message data from multiple heterogeneous communication services, to perform text normalization and removal of redundant thread content, to execute linguistic tokenization and extraction of statistical and rule-based keyword features, and to generate structured analysis input data including message attributes, keyword lists, and rule-based hint information; a processor further configured to transmit, to a generative artificial intelligence model, input information including the structured analysis input data together with a prompt sentence that specifies an output format for urgency, importance, and keywords, to receive response information from the generative artificial intelligence model, to extract classification results and feature values from the response information, to convert the classification results and feature values into numerical scores, and to integrate the numerical scores with outputs of a separately trained classification model that is updated using user operation history; a processor further configured to determine final urgency and importance for each message based on the integrated scores, to allocate each message to one of a high-priority queue, a normal-priority queue, and a low-priority queue, to generate, for messages in the high-priority queue, notification payloads that include short summaries produced by the generative artificial intelligence model in accordance with a notification-specific prompt sentence, and to transmit the notification payloads to a user terminal via a notification infrastructure; and a processor further configured to group messages in the low-priority queue according to time-based or category-based conditions, to transmit, to the generative artificial intelligence model, input information including a summarization-oriented prompt sentence that specifies extraction policies for decision information, issue information, and deadline information, to receive and store summary information for each group, and to modify contents of subsequent prompt sentences and model behavior dynamically based on user operations such as notification openings, ignores, priority changes, and sender-based setting changes. This enables the computing system to technically improve resource utilization by reducing redundant interrupt events at the user terminal, by minimizing unnecessary message re-processing through adaptive classification and queue allocation, by structuring both raw messages and summaries as machine-usable data optimized for downstream retrieval and routing, and by coordinating deterministic preprocessing, learned models, and generative AI models via explicit prompt sentences to achieve more accurate and efficient prioritization and summarization of multi-channel messages.

The term “system” refers to a collection of one or more computing devices and associated software modules that cooperate to perform message acquisition, analysis, prioritization, notification, and summarization processing as described herein. The term “processor” refers to any data processing circuitry, including but not limited to a central processing unit, a microprocessor, a microcontroller, a digital signal processor, or a plurality of such elements operating together, that executes instructions to implement the functions described in the claims.

The term “message acquisition unit” refers to a functional component implemented by the processor that obtains message data from multiple communication services, converts the obtained data into a unified internal representation, and stores the unified data for subsequent processing.

The term “natural language processing unit” refers to a functional component implemented by the processor that performs operations such as text normalization, tokenization, morphological analysis, part-of-speech tagging, keyword extraction, and context analysis on message text.

The term “notification generation unit” refers to a functional component implemented by the processor that constructs and outputs notification payloads for high-priority messages, including at least summary text and metadata, and that delivers such payloads to a user terminal via a notification infrastructure.

The term “summary generation unit” refers to a functional component implemented by the processor that groups low-priority messages, generates summary information describing such groups, and stores and provides the summary information through one or more delivery channels.

The term “information processing device” refers to any hardware platform capable of executing software instructions, including but not limited to a server device, a client device, a user terminal, or a network appliance.

The term “communication service” refers to any service that exchanges digital messages over a network, including but not limited to electronic mail services, chat or messaging services, and real-time collaboration or business communication platforms.

The term “message” refers to any unit of communication data received from a communication service, including but not limited to an electronic mail item, a chat post, an instant message, or a notification event, having at least text content and associated metadata.

The term “text normalization” refers to processing operations that convert message text into a standardized form, including but not limited to character encoding normalization, removal of markup or structured document tags, and deletion of redundant portions of message threads. The term “tokenization” refers to the process of segmenting message text into smaller units, such as words, subwords, or symbols, that can be individually analyzed by subsequent linguistic or statistical methods.

The term “morphological information” refers to information about the internal structure of tokens, including but not limited to base forms, inflection types, and conjugation patterns. The term “part-of-speech information” refers to syntactic category labels assigned to tokens, such as noun, verb, adjective, adverb, or other grammatical classes.

The term “keyword” refers to a token or phrase that is identified as having relatively high importance within a message according to a statistical or rule-based measure.

The term “statistical indicator” refers to a quantitative measure used to assess term importance or message features, including but not limited to frequency, inverse document frequency, or other numerical metrics derived from a collection of messages.

The term “rule-based keyword feature” refers to a keyword or attribute detected according to predefined patterns or rules, such as detection of urgency-related terms or deadline-related terms in message text.

The term “urgency-related term” refers to a word or phrase indicating time-criticality or immediacy, such as terms that explicitly or implicitly request prompt action.

The term “deadline-related term” refers to a word, phrase, or expression that specifies or implies a due date, time limit, or expiration for a task or request described in a message. The term “attribute information of a message” refers to metadata associated with a message, including but not limited to sender identifiers, recipient identifiers, timestamps, subject text, message source type, and thread identifiers.

The term “hint information” refers to auxiliary information derived from rule-based analysis, indicating preliminary assessments such as likely urgency, presence of deadlines, or type of requested action.

The term “analysis input data” refers to a structured data object produced by the processor that includes at least attribute information of a message, extracted keywords, and hint information, and that is intended to be consumed by a generative AI model or another analysis component.

The term “generative AI model” refers to a machine-learning model configured to generate or transform text or structured data from an input prompt, including but not limited to a large language model that outputs classification labels, keywords, summaries, or other textual results.

The term “prompt sentence” refers to a textual instruction or query provided as part of input information to a generative AI model, which guides the model regarding the task to perform and the desired output format.

The term “input information” refers to data transmitted to a generative AI model, including at least one prompt sentence and associated analysis input data containing message-related information.

The term “response information” refers to data returned from a generative AI model in response to input information, including at least textual or structured outputs representing urgency, importance, keywords, summaries, or other requested results.

The term “classification result” refers to a label or category assigned to a message or feature by a model, such as urgency level or importance level, as produced by the generative AI model or a separate classification model.

The term “feature value” refers to a numerical or categorical representation of a characteristic of a message, such as a keyword score, length, or presence of specific patterns, used as input to a classification model.

The term “numerical score” refers to a quantitative value derived from classification results or feature values, representing degrees of urgency, importance, or other priorities for a message. The term “classification model” refers to a machine-learning model, including but not limited to a statistical learning model or a neural network, that receives feature values as input and outputs classification results, such as estimated urgency or importance.

The term “user operation history” refers to recorded data describing user interactions with notifications, messages, and system settings, including but not limited to opening actions, ignoring actions, priority changes, and sender-based configuration changes.

The term “high-priority queue” refers to a data structure or logical list in which messages classified as having high urgency and high importance are stored for immediate notification processing.

The term “normal-priority queue” refers to a data structure or logical list in which messages classified as having moderate urgency or importance are stored for standard processing without immediate high-priority notification.

The term “low-priority queue” refers to a data structure or logical list in which messages classified as having low urgency and low importance are stored for deferred processing and summarization.

The term “notification payload” refers to a structured data object constructed for delivery to a user terminal, including at least a summary of a message, sender information, priority information, and any additional data required by a notification infrastructure.

The term “notification infrastructure” refers to a communication mechanism or service for delivering notifications from the server to user terminals, including but not limited to push notification services, messaging gateways, or operating system notification services.

The term “user terminal” refers to any client device operated by a user, including but not limited to a mobile device, a desktop device, or a web-enabled device, that receives notifications and displays or outputs information to the user.

The term “grouping of messages” refers to the process of assigning multiple messages to sets based on one or more grouping criteria, such as time intervals, categories, projects, or sender attributes, for collective summarization.

The term “time-based condition” refers to a grouping criterion that uses time information, such as a day or hour, to group messages that fall within a specified temporal range. The term “category-based condition” refers to a grouping criterion that uses logical categories, such as topic, project, department, or label, to group messages with similar attributes or content.

The term “decision information” refers to information in one or more messages that indicates conclusions, approvals, or determinations made by one or more parties.

The term “issue information” refers to information in one or more messages that identifies open problems, questions, or unresolved matters requiring attention.

The term “deadline information” refers to information in one or more messages that defines or implies specific time limits or due dates associated with tasks or actions.

The term “summary information” refers to condensed content generated for a group of messages, including at least key points such as decisions, issues, and deadlines derived from the messages.

In one embodiment, a server, a terminal, and a user cooperate to implement a message processing system that prioritizes and summarizes multi-channel messages using a combination of deterministic natural language processing, machine-learned classification, and a generative AI model controlled by prompt sentences. The server executes software modules on one or more processor cores and manages persistent storage, while the terminal executes client software that interacts with an operating system notification subsystem and a rendering engine for user interfaces.

The server uses general-purpose hardware, such as a multi-core central processing unit, random access memory, non-volatile storage, and a network interface controller. The server executes an operating system such as a general-purpose server operating system and an application runtime such as a high-level programming language interpreter or virtual machine. The server stores program instructions and configuration data in a database system such as a relational database or a document-oriented database.

The server acquires messages from heterogeneous communication services by executing a message acquisition unit. The server connects to electronic mail services using standardized mail protocols such as a post office protocol or an internet message access protocol, implemented via a mail client library running in the server process. The server connects to chat or messaging services using a request-response protocol over a secure transport layer, implemented via an HTTP client library. The server connects to real-time communication services using a bidirectional persistent-connection protocol such as a WebSocket protocol, implemented via a WebSocket client library.

The server represents each message in a unified internal data structure, for example, a JSON-like object with fields including a message identifier, sender identifier, recipient identifiers, timestamp, source type, subject text, body text, attachments metadata, and thread identifier. The server stores these unified message objects in a database table or collection and marks each message with a status indicating processing progress.

The server performs text normalization on the message body text as part of a natural language processing unit. The server decodes character encodings into a normalized encoding such as UTF-8. The server removes markup elements including HTML tags and inline styling using an HTML parser. The server applies pattern-based rules to detect and remove quoted previous threads and signatures, for example by recognizing delimiter lines such as “Original Message” or common signature separators. By removing redundant thread content, the server reduces the length of text to be processed, thereby reducing CPU cycles for subsequent analysis and lowering memory footprint for token and feature storage.

The server segments the normalized text into tokens using a language-specific tokenizer. For languages with whitespace-separated words, the server uses a statistical tokenizer and part-of-speech tagger, for example as provided by a natural language processing library. For languages with non-whitespace boundaries, such as character-based languages, the server uses a morphological analyzer such as a dictionary-based segmenter or a statistical segmenter. The server extracts morphological information such as lemma and inflection type and assigns part-of-speech tags to each token. The server stores token sequences, lemmas, and tags in an indexed structure associated with the corresponding message identifier. This indexed structure enables efficient reuse of tokens for keyword extraction and model feature computation without re-processing the original text.

The server computes keyword features using statistical indicators and rule-based patterns. The server maintains a term-document matrix for a sliding window of recent messages and computes term frequency-inverse document frequency values for each token or phrase. The server selects top-ranked terms per message as candidate keywords. The server also applies regular expression patterns and lexicon-based rules to detect urgency-related terms such as “urgent,” “ASAP,” or equivalent terms in other languages, and deadline-related terms such as dates, days of week, and expressions like “by end of day” or “due tomorrow.” The server encodes the presence or absence of such patterns as binary features, and encodes the relative temporal proximity of detected dates to the current time as numerical features. The server constructs analysis input data for each message by combining attribute information, keyword lists, and rule-based hint information. Attribute information includes at least sender category (for example internal, external, automated system), message length, number of recipients, and historical interaction metrics such as average open time for the sender. The server serializes this analysis input data into a structured representation suitable for input to both a discriminative classification model and a generative AI model. The server implements a separate classification model using a supervised learning framework. In one embodiment, the server uses a gradient boosting decision tree model trained on feature vectors derived from tokens, keyword counts, sender attributes, and rule-based hints, with labels representing urgency and importance levels determined from past user operation history. In another embodiment, the server uses a neural network classifier, such as a multi-layer perceptron with rectified linear activation functions, trained to output urgency and importance scores. The server trains these models using a loss function such as cross-entropy for categorical labels or mean squared error for continuous scores. The server updates model parameters by performing gradient-based optimization, such as stochastic gradient descent or an adaptive moment estimation algorithm, on batches of training examples derived from logged user interactions. The server periodically retrains or fine-tunes the model as new user operation history becomes available.

The server uses a generative AI model to refine classification and generate human-readable summaries. The generative AI model is, for example, a transformer-based large language model deployed either as a remote service reachable via an HTTP API or as a local inference engine running on a server equipped with a processor and an accelerator such as a graphics processing unit. The generative AI model includes multiple layers of self-attention and feed-forward sub-networks, with learned parameters optimized on large text corpora.

The server does not rely on the generative AI model as a black box; instead, the server controls the model through explicit prompt sentences that define tasks and output formats. The server constructs a prompt sentence for urgency evaluation such as:

“Please evaluate the urgency of this message and extract important keywords. Return the urgency (high, medium, or low), the importance (high, medium, or low), and a list of up to five keywords.”

The server appends the normalized message text and, optionally, examples of previously labeled messages, for example:
“Example of a high-priority message:
[Example text]
Label: urgency=high, importance=high
Example of a low-priority message:
[Example text]
Label: urgency=low, importance=low
Target message:
[Current message text]”

The server transmits this text input to the generative AI model and receives a response containing labeled urgency and importance and extracted keywords. The server parses the response using deterministic parsing rules, maps the textual labels to numerical scores, and merges these scores with the scores produced by the classification model. By combining the discriminative model's structured feature-based perspective with the generative model's context-sensitive textual reasoning, the server achieves improved robustness to domain shifts and rare phrase patterns.

The server further improves alignment with user preferences by modifying prompt sentences according to user operation history. When the user repeatedly marks messages from a specific sender as important, the server generates a prompt sentence such as:

“The user usually treats messages from this sender as high priority. Considering this preference, please decide the urgency (high, medium, or low) and importance (high, medium, or low) of the following message and explain briefly.”

The server appends representative examples from that sender and their labels, thereby enabling the generative AI model to condition its output on user-specific patterns without retraining the underlying model. This prompt-level adaptation reduces the number of misclassifications that would otherwise be corrected by future user feedback, thereby reducing the number of training iterations and inference calls needed over time.

The server allocates each message to a priority queue based on the integrated numerical scores. The server maintains a high-priority queue, a normal-priority queue, and a low-priority queue, each implemented as an in-memory or persistent queue structure. Messages in the high-priority queue trigger notification processing; messages in the low-priority queue are held for batch summarization; messages in the normal-priority queue are made available for on-demand viewing without immediate alerts. By partitioning messages into separate queues at the server level, the system reduces the volume of real-time notifications transmitted to the terminal and decreases interrupt frequency at the operating system level of the terminal. The server generates notification payloads for messages in the high-priority queue. The server calls the generative AI model with a prompt sentence such as:

“Please create a one-sentence summary of this message highlighting the main issue and urgency in no more than 80 characters.”

The server appends the message text and receives a concise summary. The server constructs a notification payload including the short summary, sender information, message identifier, and priority level. The server then transmits this payload to a push notification infrastructure. Because the server pre-computes a compact, context-sensitive summary, the terminal can display informative notifications without retrieving full message content in real time, thereby reducing network bandwidth and latency.

The terminal receives notification payloads via a push notification service integrated with the terminal's operating system. The terminal parses the payload and uses a notification manager component of the operating system to display a notification banner or alert. The terminal may also use a text-to-speech engine to read the short summary aloud, depending on user settings. The terminal records whether the user opens or ignores the notification and transmits this operation as user operation history back to the server. By using the operating system's native notification and audio subsystems, the system directly controls hardware resources such as display, speaker, and vibration motors in a structured way and reduces application-level polling.

The server aggregates messages in the low-priority queue for batch summarization. The server selects grouping criteria, such as all low-priority messages received within a day or all low-priority messages associated with a specific category or project. For each group, the server concatenates message texts and constructs a summarization-oriented prompt sentence such as: “Please summarize the following messages and extract the key points. Focus on decisions, open issues, and deadlines. Output several bullet points.”

The server transmits the prompt sentence with the grouped texts to the generative AI model and receives a structured summary that enumerates decisions, open issues, and deadlines as separate bullet points. The server stores this summary in a dedicated summary data structure associated with the grouping key and message identifiers. The server then delivers summaries to the user via email or a web-based dashboard.

The terminal displays summaries through a user interface rendered in a web browser or a native application. The terminal requests summary data from the server and renders the group title, summary bullet points, and links to underlying messages. The user can filter summaries based on date or category, and the terminal transmits filter selections to the server. The server adjusts grouping and summarization parameters accordingly for subsequent batches. The server uses the user operation history to update the classification model. When the user changes a message's priority, opens or ignores notifications, or modifies sender-based rules on the terminal, the terminal sends these events as feedback records. The server encodes these events as labeled examples for the classifier, constructs feature vectors aligned with those used during initial training, and periodically performs incremental training. The server computes gradients of a loss function with respect to model parameters and updates parameters using an optimization algorithm. The server may also apply data augmentation, such as synonym substitution or minor paraphrasing, to increase robustness of the classifier to linguistic variability. This incremental training reduces classification error rates over time and allows the system to adapt to shifts in user behavior or message types.

The server's orchestration of deterministic preprocessing, feature-based classification, and prompt-controlled generative modeling yields concrete technical effects that go beyond simple automation of human reading. The removal of redundant thread content and normalization of encoding reduce processing time for tokenization and model inference. The use of indexed token and feature stores improves cache locality and reduces repeated computation for similar messages. The queue-based allocation mechanism reduces the number of notifications that reach the terminal, which in turn reduces interrupt handling in the terminal's operating system, lowers energy consumption, and enhances responsiveness of other applications. The adaptive prompt design, which incorporates user-specific examples and sender attributes, reduces the volume of mis-prioritized messages and thereby decreases the number of corrective interactions and retraining cycles required, improving overall computational efficiency.

In another embodiment, the server deploys the generative AI model locally on a specialized inference server equipped with a graphics processing unit or other accelerator. The server loads a transformer architecture with multiple attention heads and uses half-precision floating-point parameters to reduce memory bandwidth and inference latency. The server precomputes token embeddings for frequent phrases such as common urgency-related terms, caching these embeddings across inference calls. By managing model parameters, embedding caches, and batching of inference requests, the server reduces the average processing time per message and increases throughput for message classification and summarization tasks.

In yet another embodiment, the server uses different generative AI models or different prompt templates for different message domains. For example, the server applies one model configuration with domain-specific vocabulary for technical incident messages and another configuration for administrative announcements. The server selects the appropriate model or prompt by inspecting sender attributes or message metadata. This specialization further improves classification and summarization accuracy and reduces the need for long prompts, thus lowering network payload size and inference time for remote AI services.

The server, the terminal, and the user thereby form an integrated technical system in which multi-channel message streams are transformed into structured, prioritized, and summarized data in a way that improves computational efficiency, reduces communication load, and enhances the operation of hardware and software components. The described configuration, including the explicit control of a generative AI model via prompt sentences, the use of learned classification models cooperating with deterministic rules, and the queue-based routing of messages, enables a concrete improvement in computer technology rather than a mere automation of human reading and decision-making.

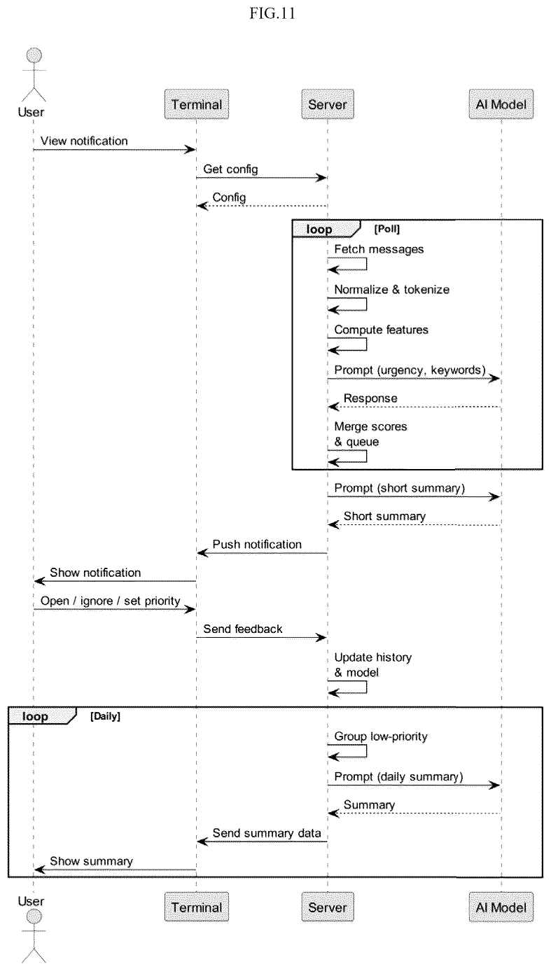

The following describes the processing flow using FIG. 11.

### Step 1:

Server receives configuration and initializes connections.

Server uses configuration data (input: configuration file including service endpoints, authentication credentials, polling intervals, and model API parameters) to create internal objects representing each communication service and AI service. Server parses the configuration, validates formats, and stores parameters in memory structures. Server then opens network connections to mail servers, HTTP-based messaging services, and WebSocket endpoints, and performs authentication handshakes. As a result of this data processing and protocol negotiation (output: active network sessions and an in-memory configuration state), server is prepared to request and receive messages and to call a generative AI model.

### Step 2:

Server acquires raw messages from multiple services.

Server takes as input the active network sessions and service-specific cursors or timestamps that indicate the last retrieved message. Server issues protocol-specific commands (for example, search and fetch for mail, GET requests for REST APIs, subscription messages for Web Socket) to obtain new messages. Server receives raw data streams containing headers, bodies, and metadata in heterogeneous formats. Server converts these heterogeneous inputs into a unified message object format by parsing headers, decoding body content, and mapping fields to a common schema (output: a list of unified raw message objects stored in a database with status “raw_unprocessed”).

### Step 3:

Server normalizes and cleans message text.

Server reads unified raw message objects from storage (input: message objects with encoded body text and possible HTML or markup). Server decodes character encoding into a standard encoding, removes HTML tags and styling using an HTML parser, and applies pattern-based rules to detect and delete quoted previous threads and signature blocks. Server writes the cleaned text back into the message object and updates the processing status (output: normalized message objects with plain-text bodies and reduced length). This transformation reduces text length and noise, which lowers subsequent computational load and improves analysis accuracy.

### Step 4:

Server tokenizes text and attaches linguistic annotations.

Server takes normalized message text as input. Server applies a language detector to choose an appropriate tokenizer and morphological analyzer. Server then segments the text into tokens, assigns part-of-speech tags, and derives lemmas or base forms. Server constructs a token sequence data structure that references the original message identifier and stores token features (output: token lists and linguistic metadata linked to each message). By generating this representation, server enables downstream algorithms to treat human language text as structured numerical and categorical data.

### Step 5:

Server computes statistical keyword scores and rule-based flags.

Server uses token lists and term frequency statistics as input. Server calculates term frequencies for each message and inverse document frequencies across a corpus window, then multiplies these to obtain keyword scores per token or phrase. In parallel, server evaluates rule-based patterns on the token sequences to detect urgency-related terms, deadline-related terms, and other domain-specific markers. Server then selects top-scoring terms as keywords and sets binary or numeric flags for detected patterns (output: enriched message objects containing keyword lists, TF-IDF scores, and rule-based hint flags). This data computation transforms text into feature vectors that quantify importance and urgency-related cues.

### Step 6:

Server builds structured analysis input data for models.

Server takes enriched message objects (with attributes, tokens, keyword scores, and hint flags) as input. Server selects a subset of fields and encodes them into a feature vector for a classification model, and simultaneously formats a text block for the generative AI model.

Server constructs a prompt sentence such as “Please evaluate the urgency of this message and extract important keywords. Return the urgency (high, medium, or low), the importance (high, medium, or low), and a list of up to five keywords.” Server appends message content and, optionally, few-shot examples to this prompt. The output is two parallel structures: numerical feature vectors for a discriminative classifier and text-based input information (prompt sentence plus message text) for the generative AI model.

### Step 7:

Server performs discriminative classification of urgency and importance.

Server inputs the numerical feature vectors into a pre-trained classification model stored in memory. Server computes model outputs by applying learned weights and activation functions layer by layer, generating predicted probabilities or scores for urgency and importance levels. Server maps these probabilities to numerical scores and categorical labels (output: preliminary urgency and importance scores and labels for each message). This computation provides a fast, structured baseline estimate that leverages token and metadata features.

### Step 8:

Server invokes the generative AI model with prompt sentences.

Server sends the text-based input information (including the prompt sentence and message text) via a network interface to a generative AI model endpoint. Server serializes the input as an API request, including model parameters such as temperature and maximum response length. The generative AI model receives the prompt and internally performs sequence processing; from the server's perspective, the input is the prompt text, and the output is response text containing labeled urgency, importance, and keywords. Server receives this response and parses it according to the requested output format (output: AI-derived urgency label, importance label, and keyword list). This interaction allows server to leverage context-sensitive reasoning beyond fixed features.

### Step 9:

Server integrates classifier scores and generative AI outputs.

Server uses as input the preliminary scores from the discriminative classifier and the labels and keywords from the generative AI model. Server maps textual labels to numerical scores and combines them with classifier scores using a defined aggregation rule (for example, weighted average or rule-based override when urgency is classified as high by either model). Server also updates keyword lists by merging classifier-selected keywords with generative AI-extracted keywords and removing duplicates. The output is a final urgency score, a final importance score, and a consolidated keyword set for each message. This data fusion step exploits complementary strengths of both models and reduces error variance.

### Step 10:

Server assigns messages to priority queues.

Server takes final urgency and importance scores as input. Server compares these scores against threshold values configured in the system. Based on the comparison, server writes each message identifier into one of three queue data structures: high-priority, normal-priority, or low-priority. Server updates the message record with its assigned queue and classification results (output: prioritized queues ready for targeted processing). By converting continuous scores into queue membership, server structurally separates processing paths, which allows downstream modules to operate with different frequencies and resource budgets. Step 11:

Server generates notification payloads for high-priority messages.

Server selects message identifiers from the high-priority queue as input. For each selected message, server prepares a notification-oriented prompt sentence such as “Please create a one-sentence summary of this message highlighting the main issue and urgency in no more than 80 characters.” Server appends message text and sends this input to the generative AI model. Server receives a short summary as response and constructs a notification payload including the summary, sender metadata, message identifier, and priority label. Server serializes the payload into the format required by a push notification infrastructure and transmits it (output: delivered notification payloads available to the terminal). This data transformation compresses message content into minimal yet informative alerts, reducing transmission size and client-side processing.

### Step 12:

Terminal receives and renders notifications.

Terminal uses the operating system's notification service as input channel for incoming payloads. Terminal parses each payload, extracting the summary text, sender name, and identifiers. Terminal invokes the operating system's notification API to display a banner or alert and, if configured, calls a text-to-speech engine to vocalize the summary. The output is a visual and/or audio presentation of the summarized message on the terminal's display and speaker. Terminal also records user interaction events, such as tapping or dismissing the notification, as feedback signals for later transmission.

### Step 13:

User interacts with notifications and detailed message views.

User receives the notification on the terminal and can choose to open it, ignore it, or perform actions such as marking the message as not urgent or pinning it as critical. When the user taps the notification, terminal uses the message identifier (input) to request full message details from the server via a network API. Terminal displays the full message, along with extracted keywords and priority labels. When the user performs a feedback action, terminal packages the action type, message identifier, and timestamp (output: feedback record) and sends this record to the server. This interaction provides labeled data that influences later classification and prompt adaptation.

### Step 14:

Server logs feedback and updates user operation history.

Server receives feedback records from the terminal as input. Server writes these records into a user operation history store, associating each record with the corresponding message and timestamps. Server may compute derived statistics such as average open delay or frequency of priority changes per sender. The output is an enriched user operation history dataset, which server uses as training data for model updates and as context for future prompt sentences. Step 15:

Server retrains or fine-tunes the classification model.

Server takes accumulated user operation history and corresponding message features as input. Server constructs training examples where each feature vector is paired with a label derived from user feedback (for example, explicit priority changes or inferred importance from open behavior). Server computes the loss between model predictions and these labels using an objective function such as cross-entropy or mean squared error. Server computes gradients and updates model weights using an optimization algorithm. The output is an updated classification model stored in memory and/or persistent storage. This iterative data computation reduces future misclassification rates and thus lowers the number of corrective user actions required.

### Step 16:

Server adapts prompt sentences based on user behavior.

Server analyzes user operation history and model performance metrics as input. Server identifies patterns such as specific senders that tend to be marked as high importance or types of content that are frequently downgraded. Server then modifies stored prompt templates by adding contextual instructions, for example: “The user usually treats messages from this sender as high priority. Considering this preference, please decide the urgency and importance of the following message and explain briefly.” The output is a set of updated prompt sentences used in later calls to the generative AI model. This adaptation changes the generative AI model's behavior without modifying its parameters, improving alignment with user preferences and reducing processing needed for retraining.

### Step 17:

Server batches low-priority messages for summarization.

Server reads identifiers of messages in the low-priority queue as input and groups them according to configured rules, such as by date or category. For each group, server concatenates the cleaned message texts and constructs a summarization prompt sentence such as “Please summarize the following messages and extract the key points. Focus on decisions, open issues, and deadlines. Output several bullet points.” Server transmits the concatenated text and prompt to the generative AI model. Server receives a multi-bullet summary as response and stores it in a summary table linked to group metadata (output: structured summary records ready for distribution). This batch processing compresses many low-impact messages into a small amount of structured data, reducing storage and retrieval overhead for the terminal.

### Step 18:

Terminal retrieves and displays summaries.

Terminal requests summary records from the server using filter parameters such as date range or category (input). Terminal receives summary data including titles, bullet-point content, and associated counts of underlying messages. Terminal renders a summary list view and detailed view components on the display. The output is a human-readable dashboard where the user can quickly review condensed information instead of loading each underlying low-priority message. Terminal can also send user-selected filters and viewing preferences back to the server, which become input for future grouping and summarization behavior.

### Step 19:

User adjusts system behavior and preferences.

User operates settings controls on the terminal, specifying rules such as “Do not send real-time notifications between certain hours” or “Treat messages containing a specific keyword as at least medium importance.” Terminal converts these settings into configuration updates (input) and transmits them to the server. Server stores the updated configuration and applies it when deciding thresholds, queue assignment, and prompt content. The output is an adapted system configuration that modifies how the message processing pipeline behaves, leading to measurable changes in notification frequency, model thresholds, and summarization scope.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented messaging systems in business environments, such as logistics centers and other operational facilities, generally acquire messages from heterogeneous communication services and present them to users in chronological order or with only simple rule-based filtering. In such systems, the processing logic executed by processors typically relies on pre-defined keyword lists, static heuristics, or manually configured rules to determine which messages are important and how they should be presented. These approaches suffer from several technical limitations.

First, because the processor applies fixed rules or shallow pattern matching to raw text, the processor is not able to accurately capture the semantic context and business-specific urgency of incoming messages. As a result, the processor often classifies messages incorrectly, for example treating non-urgent messages as urgent and vice versa. This leads to notification overload at the user interface, causing important alerts to be drowned out by low-value messages and degrading the effectiveness of real-time communication in the system. Second, typical systems are not designed to dynamically adapt the underlying text-processing behavior at the model-prompt level based on user feedback and operational history. Even when machine learning models are used, they are often trained offline and do not flexibly adjust the computational pipeline, such as prompt content sent to a remote language model or the parameters used to compute message priority. As a result, the processor cannot effectively optimize prioritization logic, notification logic, and summarization logic over time. This leads to inefficiencies in memory usage, network usage, and processor cycles, due to repeated processing of low-value messages and unnecessary transmission of verbose notifications. Third, prior systems typically handle message analysis, prioritization, notification, and summarization as separate, loosely coupled components. The processor may perform natural language processing, then independently perform notification generation, and separately generate periodic summaries using unrelated mechanisms. Because these stages are not integrated around a unified representation of model-generated analysis results and user feedback, the system fails to leverage the full capabilities of advanced generative models and cannot coordinate real-time notifications with later summaries in a technically optimized way. For example, the same message content may be redundantly processed multiple times for different purposes, increasing computational load and latency.

Fourth, known systems do not systematically use generative models with structured prompt sentences to perform both (i) urgency/importance evaluation and keyword extraction, and (ii) multi-message summarization conditioned on business-specific constraints such as role, time period, or detail level. Without a structured prompt-driven pipeline, the processor often produces unstructured outputs that are difficult to integrate into downstream priority computation and UI presentation logic. This causes additional conversion steps, complex ad-hoc parsing, and higher error rates in mapping natural language output to machine-usable data structures.

Fifth, existing architectures provide limited support for dynamically tailoring the amount and granularity of information presented to different users or devices, based on computed priority scores and statistical learning models that incorporate feedback. The processor typically sends the same notification payload or static summary to all devices, regardless of context, which can result in inefficient use of display resources, communication bandwidth, and battery power for portable terminals.

Accordingly, there is a need for an improved computer-implemented system in which a processor orchestrates acquisition of heterogeneous messages, structured interaction with a generative AI model via explicit prompt sentences, integrated computation of per-message priority based on AI-generated analysis and user feedback, and adaptive control of both real-time notification and aggregated summarization. Such a system should technically improve the way processors represent, transform, and route message data within memory and across network interfaces, so that urgent information is delivered promptly, low-priority information is batched and summarized efficiently, and the overall message-handling pipeline becomes more accurate, adaptive, and resource-efficient.

The specific processing by the specific processing unit 290 of the data processing device 12 in Application Example 1 is realized by the following means.

The present invention provides a server comprising a processor configured to acquire message data from a plurality of different communication services via communication interfaces and to normalize the message data into a common internal format stored in a memory, a processor further configured to construct, for each message, analysis input data including at least text data of the message and a prompt sentence specifying a processing content for evaluating urgency and importance and extracting keywords, to transmit the analysis input data to a generative AI model, and to store, in the memory, structured analysis result data received from the generative AI model including at least an urgency, an importance, and one or more keywords for the message, a processor further configured to compute, using the analysis result data together with operation history information and setting information of a user, a priority value for each message by executing a statistical learning model, to generate notification information for messages whose priority value is equal to or greater than a predetermined threshold and to transmit the notification information, in a format corresponding to an output channel of an information output device, to the information output device for real-time notification, and a processor further configured to aggregate messages whose priority value is lower than the predetermined threshold over a predetermined period, to construct summarization input data including text data of the aggregated messages and a prompt sentence specifying a processing content for summarization and extraction of important points, to transmit the summarization input data to the generative AI model, to store, in the memory, summary result data received from the generative AI model as aggregated summary information, and to adaptively change contents of the prompt sentences and notification control parameters based on feedback information from the user so as to dynamically adjust at least an output format of the urgency evaluation, the importance evaluation, and the summary result. This enables the server to implement an integrated, feedback-driven message-processing pipeline in which the processor uses structured interactions with the generative AI model and an updated statistical learning model to more accurately classify and prioritize heterogeneous messages, to reduce redundant processing by separating real-time notifications from batched summarization at the data-flow level, and to optimize the amount, timing, and format of information delivered to user devices, thereby improving computational efficiency, resource utilization, and responsiveness of the overall computer system.

The term “message data” refers to electronic data representing one or more communications, including at least text data and optionally metadata such as a sender identifier, a recipient identifier, a timestamp, a source type, and identifiers relating to a business object.

The term “communication application” refers to any software application or service that enables electronic exchange of messages between endpoints, including but not limited to electronic mail services, interactive text or chat services, and business management or workflow services.

The term “communication service” refers to a network-accessible service that provides a communication application via one or more communication interfaces, and that outputs or receives message data through such interfaces.

The term “communication interface” refers to any programmatic interface, including but not limited to an application programming interface, a webhook endpoint, or a message queue interface, that allows a processor to send or receive message data to or from a communication service.

The term “storage device” refers to any physical or virtual data storage resource accessible by a processor, including but not limited to volatile memory, non-volatile memory, magnetic storage, solid-state storage, and distributed storage.

The term “memory” refers to an addressable storage resource in which a processor can read and write data during operation, and includes any combination of main memory, cache memory, and other storage that is directly or indirectly accessible to the processor.

The term “normalized common format” refers to a predefined data structure in which message data from heterogeneous communication services is converted into a unified schema, such that different original formats share consistent fields such as a message identifier, source type, reception time, and text data.

The term “text data” refers to a sequence of characters or tokens representing human-readable content of a message, excluding or including markup, and suitable for processing by a natural language processing algorithm or a generative AI model.

The term “attribute information” refers to structured data items associated with a message, including but not limited to a source type, a reception time, an urgency, an importance, one or more keywords, a priority value, and identifiers for related objects.

The term “message acquisition unit” refers to one or more functions executed by a processor that are configured to obtain message data from a plurality of communication services and to store the obtained message data in a storage device.

The term “natural language processing unit” refers to one or more functions executed by a processor that are configured to analyze text data of messages using natural language processing techniques, including preprocessing, tokenization, and interaction with a generative AI model.

The term “notification generation unit” refers to one or more functions executed by a processor that are configured to generate notification information based on analysis result data or priority values of messages and to format and transmit such notification information to an information output device.

The term “summary generation unit” refers to one or more functions executed by a processor that are configured to aggregate multiple messages and to generate summary information for the aggregated messages, at least partially by using a generative AI model.

The term “analysis target data” refers to input data constructed for analysis of a message, the input data including at least text data of the message and a prompt sentence that specifies a processing content requested from a generative AI model.

The term “summarization input data” refers to input data constructed for summarization of a plurality of messages, the input data including text data of the messages and a prompt sentence that specifies a processing content of summarization and extraction of important points.

The term “prompt sentence” refers to textual instruction data that describes a desired processing content or output format for a generative AI model, and that is combined with message text data to form input data for the generative AI model.

The term “generative AI model” refers to a machine-implemented model that generates output data, including natural language text or structured data, in response to input data including at least one prompt sentence and optionally context data, and that is trained using machine learning techniques such as deep learning.

The term “analysis result data” refers to structured data produced by a generative AI model in response to analysis target data, including at least an urgency value, an importance value, and one or more keywords associated with a message.

The term “summary result data” refers to structured or semi-structured data produced by a generative AI model in response to summarization input data, the data including at least summarized content representing a plurality of messages and optionally important points or recommended actions.

The term “urgency” refers to a measure or category indicating how quickly a message should be addressed, and may be expressed, for example, as a discrete level such as high, medium, or low, or as a numeric score.

The term “importance” refers to a measure or category indicating a relative significance or impact of a message in a given context, and may be expressed, for example, as a discrete level such as high, medium, or low, or as a numeric score.

The term “keyword” refers to a term, phrase, or entity extracted from text data of a message, which is indicative of a topic, object, or condition relevant to processing or prioritization of the message.

The term “priority value” refers to a numeric or categorical measure computed for a message based on analysis result data, user-related data, and optionally model outputs, and used to determine a relative processing or notification order for the message.

The term “priority score” refers to a numeric representation of a priority value, typically produced by a statistical learning model, which is used to compare messages or to map messages to priority categories.

The term “statistical learning model” refers to a machine-implemented model, such as a regression model, a classification model, or a neural network, that is trained on feature data and associated labels to predict values such as a priority score, an urgency, or an importance. The term “feature data” refers to a set of numerical or categorical values derived from message data, analysis result data, user feedback information, or other context, and formatted as input to a statistical learning model.

The term “operation history information” refers to data representing past interactions of a user with messages or notifications, including actions such as marking messages as important, handled, or ignored, and times at which such actions were performed.

The term “setting information” refers to configuration data associated with a user or device, including preferences for notification channels, notification timing, thresholds for priority, and desired detail levels for summaries.

The term “feedback information” refers to data indicating an evaluation or preference disclosed by a user regarding analysis results, summaries, notifications, or system behavior, and may include explicit ratings, labels, or adjustments to settings.

The term “information output device” refers to any device configured to present information to a user, including but not limited to a portable information terminal, a stationary terminal, a display apparatus, and a combined input-output terminal.

The term “portable information terminal” refers to any handheld or mobile device configured to communicate with a server and to display notifications or summaries to a user, including but not limited to smartphones and tablet terminals.

The term “display device” refers to an apparatus that provides a visual output interface for presenting notifications, summaries, or message details, and may include integrated or external display modules.

The term “output channel” refers to a communication path and associated format by which notification information or summary information is delivered from a server to an information output device, including but not limited to push notifications, web protocols, or application-specific channels.

The term “notification information” refers to data representing at least a subset of message data and analysis result data, formatted for presentation as an alert or message to a user via an information output device.

The term “summary information” refers to data representing aggregated and condensed content of multiple messages, optionally including important points and recommended actions, suitable for later confirmation by a user.

The term “aggregated summary information” refers to summary information generated for a set of messages collected over a predetermined period or according to a grouping criterion such as work type, role, or topic.

The term “real-time notification” refers to a notification operation in which notification information is transmitted and presented to a user with minimal delay after a triggering event, such as receipt or classification of a message.

The term “grouped message text data” refers to text data of messages that have been assigned to a group based on one or more criteria such as work type, topic, sender, or time period, for collective processing or summarization.

The term “processing content” refers to a description of a task or behavior requested from a generative AI model, such as evaluating urgency, evaluating importance, extracting keywords, generating a summary, or proposing actions.

The term “constraint conditions of the prompt sentence” refers to parameters or directives contained in, or associated with, a prompt sentence that limit or specify aspects of output from a generative AI model, including length constraints, language, format, granularity, or focus topics.

The term “user interface” refers to any combination of software and hardware through which a user can view notifications, summaries, or message details, and can provide inputs such as feedback, configuration changes, or message actions.

The term “user” refers to any human or automated agent that interacts with the system by receiving notifications or summaries, providing feedback, or configuring system behavior. The term “server” refers to one or more computing apparatuses, each including at least a processor and a memory, that collectively perform acquisition, analysis, prioritization, notification, and summarization of message data as described in the claims.

In one embodiment, a server, one or more terminals, and one or more users cooperate to implement the claimed system. The server includes at least one processor, a main memory, a non-volatile storage device, and one or more network interfaces. The server executes an operating system, such as a general-purpose server operating system, and an application program implementing a message acquisition unit, a natural language processing unit, a notification generation unit, and a summary generation unit. The terminals each include a processor, a display device, an input device, a memory, and a communication interface, and execute a client application that communicates with the server and presents notifications and summaries to the user.

The server uses a relational database management system, such as a general-purpose SQL database, stored on a magnetic disk drive or a solid-state drive as the storage device. The server allocates in the database a messages table, an analysis results table, a priorities table, a summaries table, a user settings table, and a feedback table. Each message record includes at least a message identifier, a source type, a reception timestamp, a sender identifier, and text data. The server normalizes heterogeneous message formats received from different communication services into a common schema by converting incoming data structures (for example, email headers and bodies, chat message payloads, and business event descriptions) into this unified format.

The server executes the message acquisition unit as a background process implemented, for example, using a general-purpose programming language and a scheduling library. The server connects, over a packet-switched network, to multiple communication services, such as electronic mail services, interactive text-based communication services, and business management services, by using application programming interfaces exposed by those services. The server authenticates via token-based authentication and periodically or event-driven calls the interfaces to retrieve new message data. The server converts all retrieved message data into the normalized common format and writes it into the messages table in the storage device. Because the server stores messages in a unified schema, subsequent components can access messages without implementing service-specific parsers, which reduces duplicate parsing logic and improves cache locality in the main memory. The server executes the natural language processing unit as a separate process or module that reads message records from the database. The server first performs deterministic preprocessing on text data of each message using a natural language processing library, such as a tokenizer library. The server removes markup tags, quoted reply lines, signatures, and control characters by applying regular-expression-based filters. The server then tokenizes the cleaned text into subword tokens according to a predefined vocabulary associated with a generative AI model. The server may also perform language detection by computing character-level n-gram statistics and comparing them against language profiles stored in memory.

The server constructs analysis target data by concatenating the message text and a prompt sentence. In one example, the server generates a prompt sentence as:

“You are an assistant for an operations center. Please evaluate the urgency and importance of the following message and extract the main keywords. Output in a concise form. Message: ‘ . . . message text . . . ’”

The server stores the constructed analysis target data in the analysis results table as an input log and forwards the data to a generative AI model. In one embodiment, the server communicates with a remote generative AI model via a network interface using a secure protocol. The generative AI model is implemented as a transformer-based neural network having a plurality of self-attention layers, feed-forward layers, and layer normalization components. The model receives a token sequence corresponding to the prompt sentence and the message text, embeds the tokens using learned embedding vectors, and processes the sequence through stacked attention and feed-forward blocks.

The generative AI model is trained prior to deployment using a supervised fine-tuning procedure. A training dataset consists of pairs of input texts and labeled outputs that include urgency labels, importance labels, and keyword lists. During training, the server (or a training system) encodes each input pair into tokens and computes a loss function, such as a cross-entropy loss, between the model's predicted token sequence and the target token sequence representing the labeled urgency, importance, and keywords. The server updates the model parameters by back-propagation and gradient-based optimization, such as stochastic gradient descent with momentum or an adaptive optimizer, until the loss converges. The model may also be adapted with reinforcement learning from human feedback by defining a reward signal that increases when model-predicted urgency and importance align with human-assigned labels and decreases otherwise.

The server receives, as analysis result data, a generated text from the generative AI model that encodes, for example, “Urgency: high; Importance: high; Keywords: stock shortage, zone D, shipment today.” The server parses this text deterministically by searching for delimiters such as “Urgency:”, “Importance:”, and “Keywords:” and by splitting the subsequent substrings. The server converts the parsed values into structured fields (for example, an urgency level enumerated type, an importance level enumerated type, and a list of keyword strings) and stores them in the analysis results table. Because the server constrains the output format via the prompt sentence and uses explicit delimiters, the parsing logic is reliable and does not require complex heuristic natural language understanding on the server side.

The server additionally constructs summarization input data for a plurality of messages. The server groups messages with low urgency and low importance according to attributes such as source type, work type, or time window. For each group, the server concatenates short representations of each message (for example, first N characters or extracted subject lines) and generates a summarization prompt sentence such as:

“You are summarizing daily communications in a logistics center. Please summarize the following messages into concise bullet points and extract the main follow-up actions. Keep the summary under 300 words. Messages: ‘ . . . list of messages . . . ’”

The server sends the summarization input data to the same or a different generative AI model. The underlying transformer architecture processes the token sequence, attends over all message snippets and the prompt sentence, and outputs a condensed text that contains multiple bullet points, each representing an aggregated description. The server parses this text by recognizing line breaks or bullet markers and stores the entire summary as summary result data in the summaries table. The server associates each summary record with the identifiers of the underlying messages for tracing and auditing.

The server computes a priority value for each message using a statistical learning model. In one embodiment, the server constructs feature data for each message by combining numeric encodings of the urgency level, importance level, source type, message length, time of day, and binary flags indicating presence of certain keywords. The server also incorporates user feedback labels, such as whether the user marked the message as important or ignored it, as target values during model training. The server trains a gradient-boosted decision tree model or a feed-forward neural network to map feature data to a continuous priority score between 0 and 1. The server uses a loss function, such as mean squared error or cross-entropy, and updates model parameters by iteratively minimizing the loss over training samples stored in the feedback table.

The server updates the statistical learning model periodically, for example once per day, by retrieving newly accumulated feature-feedback pairs from the database. This incremental retraining allows the model to adapt to evolving message patterns and user behavior. Because the server uses both generative AI-produced attributes and user interaction data as features, the model can capture complex relationships that are not readily expressible by simple rules.

As a result, the priority computation becomes more accurate over time without requiring manual rule maintenance.

The server executes the notification generation unit based on the computed priority values. The server selects messages whose priority values exceed a first threshold and generates notification information for those messages. The server constructs a notification text that may incorporate a shortened description of the message and selected keywords. In some embodiments, the server further refines the notification text using a generative AI model by sending a prompt sentence such as:

“Summarize this alert in under 100 characters, focusing on what must be done immediately: ‘ . . . message text . . . ’”

The server converts the notification information into a data structure suitable for a particular output channel, such as a push notification format for a portable information terminal or a structured payload for a web-based dashboard. The server transmits the formatted notification via a push notification service or a web protocol. The server records, in the database, a notification log that associates each message with the time and destination device of the notification.

The terminal receives the notification through its communication interface, decodes the payload, and displays a visual alert on the display device. The terminal shows, for example, a title line in a larger font and a short description in a smaller font, and may change background color or play an alert sound when the priority level is high. The user interacts with the notification by selecting it, dismissing it, or marking it as handled. The terminal sends the user's action back to the server, which updates the corresponding message status and records the user's operation history information in the feedback table.

The server executes the summary generation unit for messages whose priority values are below a second threshold. The server aggregates such messages by time period and role and generates summarization input data with a prompt sentence such as: “Please summarize the following low-priority messages and extract only the main operational points. Output 3-5 bullet points in English. Messages: ‘ . . . list of messages . . . ’”

The generative AI model processes this input and outputs a compact summary. The server stores the summary and associates it with the relevant user roles. The terminal periodically requests available summaries for the logged-in user, retrieves the summary texts, and displays them in a list view. The user can then review summaries at convenient times without being interrupted by each low-priority message.

The server adapts the contents of the prompt sentences and the notification behavior based on feedback information stored in the feedback table. For example, if the user frequently indicates that summaries are too long, the server modifies length constraints in the summarization prompt sentence from “under 300 words” to “under 150 words.” If the user regularly reclassifies messages of a certain source type as important, the server increases weights associated with that source type in the priority model. Because the server programmatically adjusts both the feature weighting in the statistical learning model and the structure of prompt sentences for the generative AI model, the system can optimize resource usage and information density at the computer system level rather than manually tuning human-readable rules.

The use of the generative AI model in this system is not limited to replacing human judgment; rather, the server uses the model as a computational component that transforms unstructured text into structured attributes under machine-enforceable formats. The combination of structured prompt sentences, delimiter-based parsing, and model outputs yields machine-usable data that directly influences memory organization and network traffic patterns. Specifically, by distinguishing messages early into high-priority and low-priority categories based on model-derived attributes, the server can allocate CPU time and network bandwidth preferentially to high-priority messages, while batching and compressing low-priority ones. This reduces the number of transmissions and graphical updates required for low-priority messages on the terminals, thereby reducing communication load and power consumption. The server also improves processing speed and accuracy compared to conventional rule-based systems. Traditional approaches rely on static keyword lists and regular expressions, which either miss context-dependent urgency or require complex, manually designed rule sets that are inefficient to evaluate. In contrast, the transformer-based generative AI model captures long-range dependencies and semantic relations in the message text via multi-head self-attention, so the server can obtain urgency and importance estimations that align more closely with operational reality. Because the server then uses a compact feature vector built from these estimations and other attributes, the statistical learning model can compute a priority score with fewer features and fewer conditional branches, reducing CPU branch mispredictions and cache misses.

In one variation, the server deploys the generative AI model locally on a machine with a graphics processing unit. The server loads the model parameters into GPU memory and executes inference using batched token sequences. The server thereby reduces network latency and improves throughput by eliminating remote calls. In another variation, the server uses a lighter-weight generative AI model for on-device inference in a terminal for specific use cases, such as summarizing only the locally cached messages. In both cases, the server and the terminal cooperate to choose an appropriate model variant and prompt sentence given available resources and required response time.

In another embodiment, the server employs multiple generative AI models specialized for different tasks. For example, the server uses a first generative AI model for urgency and importance analysis with prompt sentences tuned for classification-style responses, and a second generative AI model for summarization with prompt sentences tuned for multi-message aggregation. The server selects a model based on task type and message characteristics, which allows the system to trade off between accuracy and computation time. The server may also switch models dynamically based on measured latency and error rates. The system provides a technical improvement to computer technology beyond mere automation of human decision-making. By designing a data flow that starts from heterogeneous communication interfaces, passes through a structured prompt-driven generative model, and feeds into a statistical learning model that governs notification and summarization, the server optimizes the internal representation and routing of messages in memory and over network interfaces. This architecture reduces redundant accesses to the database by caching intermediate analysis results, avoids re-processing messages when generating both alerts and summaries, and decreases the number of rendered user interface updates on the terminals. As a result, the server reduces overall computing resources required to handle a given volume of messages, while increasing reliability and responsiveness of time-critical notifications.

The user benefits from improved user interfaces on the terminals. Because the terminal receives fewer but more relevant high-priority notifications, the display device shows less clutter, and the user can respond more quickly to critical events. At the same time, the terminal presents summaries that are optimized in length and granularity for the user's role and preferences, which reduces cognitive load and allows the user to understand the operational state with fewer interactions. These effects are achieved by the server's internal algorithms and data structures, not merely by re-labeling or re-ordering messages. Accordingly, the described embodiments collectively enable an implementation path for the claimed invention in which the server performs specific data processing operations using defined hardware and software components, including generative AI models and statistical learning models, and where the interplay between structured prompt sentences, feature-based priority computation, and adaptive notification and summarization leads to measurable technical effects in terms of processing speed, classification accuracy, data management, computational efficiency, and communication load reduction.

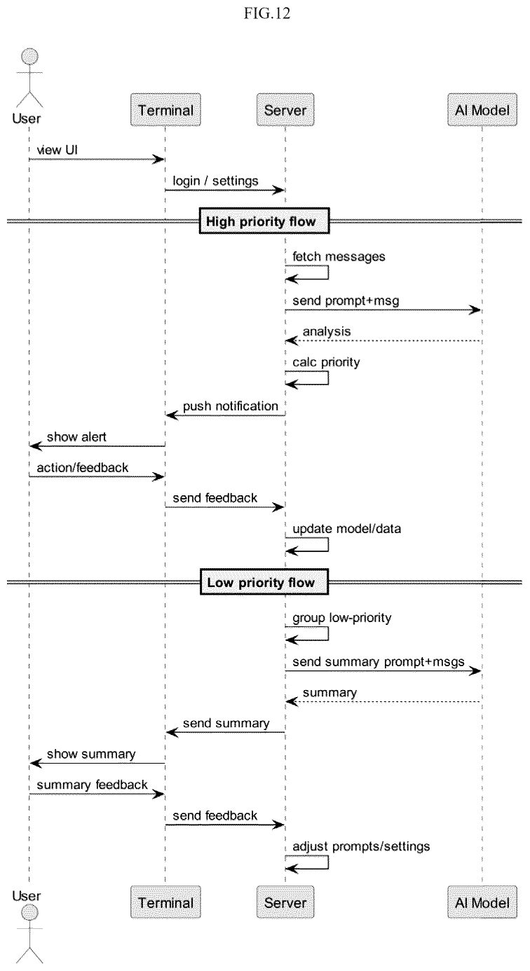

The following describes the processing flow using FIG. 12.

### Step 1:

The server acquires raw message data from multiple communication services.

The server receives, as input, service-specific payloads from electronic mail services, interactive communication services, and business management services via their communication interfaces. The server performs authentication, issues API calls (for example, “list new messages”), and receives responses containing headers, body text, timestamps, and sender information. The server processes this input by parsing each payload according to its protocol (such as MIME for email or JSON for chat), extracting at least a message identifier, a source type, a reception time, a sender identifier, and text content. The server then converts these extracted fields into a normalized common format and stores the resulting records in a messages table in a storage device. The output of Step 1 is a set of normalized message records, each including structured metadata and associated text data, with an initial status indicating that the message is unprocessed.

### Step 2:

The server performs preprocessing and tokenization of message text data.

The server takes as input the normalized message records from the messages table whose status is unprocessed. For each such message, the server retrieves the text data and applies deterministic preprocessing functions, including removal of markup tags, quoted reply sections, signatures, and control characters. The server then applies a tokenizer associated with the generative AI model to split the cleaned text into tokens based on a predefined vocabulary. The server may also compute language detection by analyzing character n-gram distributions and comparing them with stored language profiles, and records a detected language code. The server writes the cleaned text, tokenized representation, and language code back to the database or a working memory structure associated with the message. The output of Step 2 is an enriched message record that contains normalized metadata, cleaned text data, token sequences, and optionally a language code, ready for further analysis.

### Step 3:

The server constructs analysis input data and a prompt sentence for urgency and importance evaluation.

The server takes as input the enriched message record from Step 2, including cleaned text and metadata. The server generates a prompt sentence that specifies the analysis task, for example:

“You are an assistant for an operations center. Please evaluate the urgency and importance of
the following message and extract the main keywords. Output in a concise form. Message:’ . . . message text . . . ‘”

The server combines the prompt sentence and the cleaned message text into a single analysis target text string, optionally delimiting sections using markers such as “Message:” and quotation characters. The server may also attach auxiliary context, such as detected language or source type, within the prompt. The server stores the combined analysis target text as analysis input data in an analysis log structure linked to the message identifier. The output of Step 3 is an analysis input data record that encodes both the prompt sentence and the message text, ready to be sent to the generative AI model.

### Step 4:

The server transmits analysis input data to the generative AI model and receives analysis result data.

The server uses, as input, the analysis input data from Step 3 and model configuration parameters such as model name, maximum token length, and temperature. The server encodes the analysis target text into tokens using the model's tokenizer and transmits the token sequence, along with generation parameters, to the generative AI model via a network interface or a local model inference engine. Inside the generative AI model, a transformer-based neural network processes the sequence through stacked self-attention and feed-forward layers, computing attention weights and updating hidden states to capture semantic relations. The model then generates an output token sequence that expresses an analysis result in a constrained textual format, such as:

“Urgency: high; Importance: medium; Keywords: stock shortage, zone D, replenishment.” The server decodes the output token sequence back into a character string and records this string as raw analysis result text associated with the message. The output of Step 4 is the raw analysis result text produced by the generative AI model for each message.

### Step 5:

The server parses the analysis result text into structured analysis result data.

The server takes as input the raw analysis result text output from Step 4. The server performs deterministic text parsing by searching for known labels such as “Urgency:”, “Importance:”, and “Keywords:”. The server slices substrings following these labels, trims whitespace, and splits keyword lists by delimiters such as commas. The server maps textual values like “high”, “medium”, and “low” into enumerated codes or numeric levels, and stores these values as urgency, importance, and keyword fields in the analysis results table linked to the original message identifier. The server may validate parsed values against an allowed set and log any inconsistencies. The output of Step 5 is a structured analysis result record that encodes urgency level, importance level, and one or more keywords in machine-usable fields.

### Step 6:

The server constructs feature data and computes a priority value using a statistical learning model.

The server uses, as input, the structured analysis result data from Step 5 together with message attributes (source type, length of message, reception time) and historical user feedback labels associated with similar messages. For each message, the server builds a feature vector by encoding categorical attributes (such as source type and urgency level) into numeric representations (for example, one-hot vectors) and by including numeric attributes (such as message length and time-of-day indicators). The server loads a trained statistical learning model, such as a gradient-boosted decision tree model or a feed-forward neural network, from storage into memory. The server passes the feature vector into the model, computes a priority score between 0 and 1, and then maps that score to a priority category (for example, critical, high, medium, or low) using threshold comparisons. The server writes the numeric priority score and the assigned category into the priorities table and associates them with the message record. The output of Step 6 is a priority value and priority category for each message.

### Step 7:

The server generates notification information for high-priority messages.

The server takes as input message records whose priority category meets or exceeds a configured threshold, together with their structured analysis results and user settings stored in a user settings table. For each such message, the server composes a notification title and body text by combining elements such as urgency level, keywords, and a truncated message text. Optionally, the server generates a condensed notification text via a generative AI model using a prompt sentence such as:

“Summarize this alert in under 100 characters, focusing on what must be done immediately: ‘ . . . message text . . . ’”

Based on device type and user preferences, the server transforms the notification content into a device-specific payload format, such as a push notification structure for a portable information terminal or a structured JSON object for a web dashboard. The server then sends the notification payload over the appropriate output channel (for example, push notification service or web protocol) to the target terminal or display device. The server logs the notification event, including timestamp and destination, and updates the message record to indicate that notification has been issued. The output of Step 7 is a set of delivered notifications rendered on terminals or display devices for high-priority messages.

### Step 8:

The terminal receives and presents notifications and collects user actions.

The terminal takes as input the notification payloads transmitted from the server in Step 7. The terminal decodes the payload using its client application, extracts fields such as title, body text, priority level, and message identifier, and renders a visual notification on the display device as a popup, banner, or list item. The terminal may apply visual emphasis, such as color or icon changes, based on the priority level. The user then interacts with the notification by selecting it, dismissing it, or invoking actions such as “Mark as handled” or “Mark as important.” The terminal collects these user actions and packages them into feedback messages containing the message identifier, the action type, and a timestamp. The terminal sends the feedback messages back to the server via a communication interface, such as an HTTP request or a persistent connection. The output of Step 8 is user feedback data transmitted to the server and updated visual status on the terminal interface.

### Step 9:

The server records user feedback and updates training data for the statistical learning model.

The server uses, as input, the feedback messages received from the terminals in Step 8, including message identifiers and action types. For each feedback entry, the server writes a new record into a feedback table, linking user actions to the corresponding message, priority score, and analysis result data. The server interprets certain actions, such as “Mark as important” or “Ignore” for high-priority messages, as labels indicating whether its current priority assessment was correct. The server then aggregates recent feature vectors (as computed in Step 6) with their associated feedback labels to form a training dataset. Periodically, the server initiates a retraining process in which it feeds these feature-label pairs into a training algorithm for the statistical learning model (for example, gradient boosting with a chosen loss function). The server updates model parameters and stores the updated model back to the storage device. The output of Step 9 is an updated training dataset and, after retraining, an improved statistical learning model that can compute more accurate priority values.

### Step 10:

The server groups low-priority messages and constructs summarization input data.

The server takes as input message records whose priority category is below a configured summary threshold and that have not yet been summarized. The server groups these messages based on criteria such as time window, work type, or related keywords. For each group, the server extracts core text segments from the messages, such as subject lines or the first N characters of body text, and concatenates these segments into a single block of text. The server generates a summarization prompt sentence tailored to the group, for example: “You are summarizing daily communications in a logistics center. Please summarize the following messages into concise bullet points and extract the main follow-up actions. Keep the summary under 300 words. Messages:’ . . . list of messages . . . ‘”

The server combines the prompt sentence and the concatenated message excerpts to form summarization input data. The server records this summarization input data in the summaries table as a log of what will be sent to the generative AI model. The output of Step 10 is a set of summarization input data records, each corresponding to a group of low-priority messages.

### Step 11:

The server generates summary result data using the generative AI model.

The server uses, as input, the summarization input data from Step 10 and configuration parameters for a summarization-oriented generative AI model (which may share the same architecture as, or differ from, the model used in Step 4). The server tokenizes the summarization input text, transmits the tokens and settings (such as maximum output length and temperature) to the generative AI model, and initiates inference. The transformer-based model processes the combined prompt and message excerpts, attends across the entire sequence to detect patterns and redundancies, and generates a compact set of bullet-point sentences that summarize the key points and suggested actions. The server decodes the model's output tokens to a text string such as:
“Inventory for zone C requires verification tomorrow.
Minor shipment delay reported for order group X, no immediate action required.
Scheduled maintenance for conveyor line 2 at 18:00.”

The server stores this summary as summary result data in the summaries table, associating it with the underlying messages and applicable user roles. The output of Step 11 is a set of structured summaries that represent aggregated descriptions of low-priority messages.

### Step 12:

The terminal retrieves and displays summaries to the user.

The terminal takes as input summary identifiers and summary texts provided by the server in response to a request from the terminal. The terminal requests available summaries for the logged-in user or role, for example by sending a query that specifies a time period or detail level. The server responds with summary records containing summary text, creation time, and associated message counts. The terminal renders these summaries in a list or dashboard view, showing the main bullet points and allowing the user to expand or collapse sections for more or less detail. The user reads the summaries and may provide feedback such as “too detailed” or “not detailed enough.” The terminal captures this feedback, along with identifiers of the summaries, and sends it back to the server. The output of Step 12 is the visual presentation of aggregated summary information to the user and feedback data describing the user's preference regarding summary length and granularity.

### Step 13:

The server adapts prompt sentences and notification behavior based on user feedback. The server uses, as input, the feedback data from Step 12 and historical feedback stored in the feedback table, including evaluations of summary usefulness and notification relevance. The server analyzes patterns in this feedback by aggregating counts and computing statistics, such as how often a user requests shorter summaries or marks notifications as unnecessary. Based on these statistics, the server updates user-specific settings that control parameters for prompt sentences (for example, maximum word count or number of bullet points) and thresholds for priority categories. The server then modifies the template of prompt sentences dynamically, for example changing “Keep the summary under 300 words” to “Keep the summary under 150 words” for a user who consistently prefers shorter summaries. The server also adjusts notification thresholds to reduce or increase the number of real-time alerts for certain priority ranges. The output of Step 13 is an updated configuration of prompt sentence templates and notification and summarization parameters that will influence future executions of Steps 3, 7, 10, and 11, thereby refining the system's behavior over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional notification systems for electronic messages acquired from multiple information communication services typically rely on static rules or simple keyword matching to determine whether and how to notify a user. Such systems often treat all incoming messages in a uniform manner, without adequately considering nuanced semantic content, user-specific context, or the current emotional or cognitive state of the user. As a result, these systems tend to generate excessive or poorly timed notifications, which interrupt user workflows, degrade concentration, and increase cognitive load and stress. From a computer-technology standpoint, existing systems also fail to integrate heterogeneous data streams (multi-service message data, behavioral logs, and user feedback) into a unified, adaptive control loop that can be executed efficiently and consistently by a processor. In addition, while natural language processing and machine learning have been applied to prioritize messages, conventional architectures generally treat model outputs as isolated scoring functions, without leveraging a generative AI model via structured prompt sentences to jointly: (i) refine urgency and importance evaluation, (ii) generate notification text tailored to the user's current emotional state, and (iii) assist in dynamic adjustment of notification policies. Known systems typically do not maintain an integrated pipeline in which raw message data, linguistic features, behavioral statistics, emotional-state estimation, and policy parameters are all processed as linked machine-readable data structures by a single processor. This leads to fragmented implementations, inconsistent decision logic, and inefficient use of computational resources.

Moreover, existing systems are not optimized to infer a user's emotional or psychological state from fine-grained notification and operation history, such as open delays, deletion rates, and time-of-day patterns, and to feed this inferred state back into the notification and summarization process at the system level. Without such a feedback mechanism, the computer system cannot automatically adapt its behavior (e.g., suppressing high-burden notifications when the user appears to be in a high-stress state, or raising the priority of time-critical messages when the user is focused) in a technically coherent and scalable manner. This lack of adaptive control reduces the effectiveness of the underlying computing platform and results in suboptimal utilization of processing, storage, and network resources. Therefore, there is a need for a computer-implemented system and associated processing architecture that: (i) acquires messages from heterogeneous information communication services into a unified internal representation, (ii) applies natural language processing to derive structured features, (iii) cooperates with a generative AI model via explicit prompt sentences to evaluate urgency and importance and to generate suitable text outputs, (iv) estimates user emotional state from notification and operation logs using machine learning and, optionally, a generative AI model, and (v) computes a composite priority and classification for each message based on these multiple factors and a dynamically adjustable notification policy. Such a system should improve the functioning of the computer itself by providing a more efficient, data-driven control loop for notification generation and summary creation, thereby reducing unnecessary processing and network traffic and improving the timing and content of outputs delivered to user terminals.

The specific processing by the specific processing unit 290 of the data processing device 12 in Example 2 is realized by the following means.

The present invention provides a server comprising a processor configured to acquire electronic messages from a plurality of information communication services, normalize the electronic messages into unified message records, perform natural language processing on body data of the electronic messages including morphological analysis and statistical text analysis to extract word sequences, feature terms, and importance-dictionary match information, generate prompt sentences for a generative AI model based on the natural language processing results and the body data, transmit the prompt sentences to the generative AI model and parse responses including urgency and importance scores and text outputs, compute feature values from notification history and operation history received from user terminals and estimate user emotional states using a machine learning model and, optionally, the generative AI model, calculate composite priority scores for the electronic messages based on the scores from the generative AI model, the natural-language-derived feature values, the estimated emotional states, and user-specific notification policies, classify the electronic messages into notification targets and summary targets according to the composite priority scores, generate notification information for classified notification targets including, when appropriate, generating additional prompt sentences to the generative AI model to obtain neutral, low-pressure summaries for notification content, and generate summary information for classified summary targets by aggregating multiple messages over a period, constructing summary prompt sentences, and obtaining topic-organized summary text from the generative AI model. This enables an integrated computer-implemented control loop that adaptively manages message notifications and summaries across heterogeneous services, improves the precision and timing of notifications, reduces unnecessary alerts and associated processing overhead, and enhances overall system performance by leveraging structured cooperation between deterministic processing, machine learning models, and a generative AI model via explicit prompt sentences.

The term “information communication service” refers to any network-based communication service that enables sending and receiving electronic messages, including but not limited to email services, chat services, and enterprise messaging services. The term “electronic message” refers to digital information transmitted via an information communication service, including at least text data and optionally associated metadata such as sender information, recipient information, timestamps, and channel or folder identifiers. The term “message record” refers to a structured data object stored in a storage device, representing an electronic message in a unified internal format with fields such as message identifier, user identifier, service type, sender, recipient, body text, and time information. The term “body data” refers to the main text content of an electronic message, excluding protocol headers or transport-specific control data.

The term “natural language processing” refers to processing of text written in a human language to derive structured features, including operations such as tokenization, morphological analysis, part-of-speech tagging, keyword extraction, statistical text analysis, and context analysis.

The term “morphological analysis” refers to processing that segments a text string into constituent word units or morphemes and associates each unit with linguistic attributes such as part of speech and base form.

The term “statistical text analysis” refers to processing that computes numerical values representing characteristics of text, including at least term frequencies, inverse document frequencies, and derived measures such as TF-IDF for use as features in evaluation or classification.

The term “word sequence” refers to an ordered list of word units or tokens obtained from body data of an electronic message by natural language processing.

The term “feature term” refers to a word or token selected from a word sequence based on one or more criteria, such as part of speech, frequency, or TF-IDF score, for use as a representative feature of the electronic message.

The term “importance dictionary” refers to a stored collection of predefined terms or patterns that are treated as indicators of urgency, importance, or other evaluation criteria when matched against the content of an electronic message.

The term “importance-dictionary match information” refers to data indicating whether, and optionally how, terms in a word sequence or feature term set match entries in an importance dictionary, including flags or counts representing the presence or absence of such matches.

The term “basic index related to urgency and importance” refers to a numerical or categorical value derived from natural language processing results, indicating an initial estimation of how time-critical or significant an electronic message is prior to or in combination with outputs from a generative AI model.

The term “generative AI model” refers to a machine-learned model, such as a neural-network-based language model, that generates, summarizes, classifies, or evaluates text in response to natural-language input or prompt sentences.

The term “prompt sentence” refers to a natural-language instruction or query formulated as text and provided as input to a generative AI model to specify desired processing, evaluation criteria, output format, or content constraints.

The term “analysis result” refers to structured information produced by natural language processing or by a generative AI model, including but not limited to word sequences, feature terms, scores, labels, keywords, and summary text associated with an electronic message. The term “urgency score” refers to a numerical value indicating how quickly a user response to an electronic message is required, as derived from the content of the message and, optionally, from processing by a generative AI model.

The term “importance score” refers to a numerical value indicating the degree to which the content of an electronic message affects a user's activities, decisions, or priorities, as derived from the message content and, optionally, from processing by a generative AI model.

The term “keyword” refers to a word or phrase identified as salient to the meaning, topic, or priority evaluation of an electronic message, obtained from natural language processing or from a generative AI model.

The term “summary text” refers to a condensed representation of the content of one or more electronic messages, expressed as shorter text that captures key points or topics.

The term “notification history” refers to stored data describing past notification events for a user, including at least notification generation times, display times, notification types, and content identifiers.

The term “operation history” refers to stored data describing user interactions with notifications or messages, including at least open events, deletion events, setting changes, timestamps, and associated identifiers.

The term “feature value” refers to a numerical or categorical quantity computed from notification history and operation history, such as average opening delay, non-opening rate, deletion rate, night-time notification frequency, or silent-mode usage frequency.

The term “state label” refers to a categorical indicator representing an estimated emotional state or psychological state of a user, such as a label denoting focused, high-stress, relaxed, or fatigued conditions.

The term “user state information” refers to stored data associating a user with one or more state labels and related metadata, such as estimation time and confidence.

The term “machine learning model” refers to a computational model trained on data to perform tasks such as classification or regression, including but not limited to linear models, tree-based models, and neural networks.

The term “notification policy” refers to a set of rules or parameters specifying how notifications are to be controlled for a user, including at least maximum notifications per unit time, allowance or prohibition of notifications in specific time ranges, and threshold values used to distinguish notification categories.

The term “composite priority” refers to a numerical or ordered value computed for an electronic message by combining multiple factors, including urgency score, importance score, natural-language-derived features, user emotional state, and notification policy parameters. The term “immediate notification target” refers to an electronic message classified as requiring prompt notification to the user based on its composite priority exceeding a first threshold.

The term “delayed notification target” refers to an electronic message classified as requiring notification after a delay or under less aggressive conditions, based on its composite priority being between a first threshold and a second threshold.

The term “summary target” refers to an electronic message classified as not requiring an individual notification but instead to be included in aggregated summary information for later review, based on its composite priority being below a summary threshold.

The term “notification information” refers to data specifying content and attributes of a notification to be output to a user terminal, including at least a title, body text, message identifier, priority indication, and optional presentation parameters.

The term “summary information” refers to data representing an aggregation of multiple summary texts or a single summary text organized by topic or time period, and associated metadata such as user identifier and period identifier, for later reference by a user.

The term “psychological load” refers to an estimated measure of mental or emotional burden imposed on a user by an electronic message, which may be inferred from message tone, content, and related features, and represented as a numerical value or category.

The term “notification content” refers to the text and associated information included in a notification presented to a user, such as a generated summary sentence, a truncated portion of an original message, or a combination thereof.

The term “neutral tone” refers to a linguistic style of text that avoids emotionally charged or pressuring expressions and is intended to communicate information in a balanced, non-aggressive manner.

The term “user terminal” refers to an information processing device operated by a user, including but not limited to smartphones, tablet devices, portable computers, and stationary computers, that can receive and display notifications and summary information.

The term “dashboard information” refers to summary information formatted for presentation in a graphical interface that allows a user to review aggregated summaries, statuses, or metrics over time.

Server, terminal, and user cooperate to implement embodiments of the invention as described below. In each embodiment, a processor executes stored instructions to realize the functional units. The same hardware or software components may be shared among multiple functional units unless otherwise specified.

Server operates as an information processing apparatus including at least one general-purpose central processing unit, a main memory, a non-volatile storage device, and a network interface. Server runs a general-purpose server operating system such as a UNIX-like operating system and executes backend application software implemented, for example, in a high-level programming language. Server further uses a relational database management system such as a general relational database to persist message records, user state information, notification policies, and log data.

Terminal operates as a client information processing apparatus such as a smartphone, a tablet device, a portable computer, or a stationary computer, and runs a mobile or desktop operating system. Terminal executes a client application that communicates with Server via a packet-switched network using a transport protocol such as TCP/IP over HTTPS. User operates Terminal through an input device such as a touch panel, keyboard, or pointing device and receives outputs through a display and audio interface.

1. Hardware and software configuration for message acquisition and normalization Server implements a message acquisition unit by executing a communication module that interacts with multiple information communication services. Server uses, for email-type services, a message reception protocol such as IMAP or POP3 via a mail-access library such as an IMAP client library or a POP client library. Server uses, for chat or enterprise messaging services, an HTTP client library such as a generic HTTP request library to call Web APIs defined by the respective service providers.

Server maintains a configuration table in the relational database that stores, for each service, endpoint addresses, authentication tokens, and retrieval parameters (for example, folders, channels, or time windows). Server loads these parameters into memory and sequentially establishes sessions with each service. For an email service, Server transmits an IMAP SEARCH command (for example, for unread messages) and then transmits IMAP FETCH commands to retrieve headers and body segments. For a chat or enterprise messaging service, Server transmits HTTPS GET requests to endpoints such as “/conversations/{id}/messages” and receives JSON-formatted responses.

Server parses protocol-level data and JSON payloads using a parsing library and transforms raw fields into unified message records. Each message record is represented as a structured tuple including at least: a message identifier, a user identifier, a service type, sender information, recipient information, channel or folder identifiers, body data as text, sent time, and received time. Server writes these message records into database tables with normalized schemas. This normalization reduces the need for service-specific branches in subsequent processing, improving cache locality and simplifying query execution plans inside the relational database engine, which in turn enhances performance and scalability.

2. Natural language processing configuration

Server implements a natural language processing unit as a processing module that reads unprocessed message records from the database and generates linguistic feature data. Server uses a morphological analyzer such as a general-purpose Japanese morphological analysis engine with a language binding such as a Python binding. Server loads morphological dictionaries into memory and initializes internal finite-state automata or lattice data structures used by the analyzer.

Server passes body data of each message to the morphological analyzer. The analyzer segments the text into morphemes and outputs a sequence of tokens, each token containing at least a surface form, a base form, and a part-of-speech tag. Server filters out tokens with parts of speech that are not useful for priority evaluation, such as certain function words, and retains content-bearing categories such as certain nouns, verbs, and adjectives. Server then uses a text vectorization component included in a machine learning library such as a TF-IDF vectorizer. Server constructs a vocabulary index from tokenized messages and converts each message into a sparse term-frequency vector. Server computes inverse document frequency values by scanning the corpus and calculating log-scaled ratios. Server multiplies term frequencies by inverse document frequencies to obtain TF-IDF scores for each token. Server then selects feature terms whose TF-IDF scores exceed a predetermined threshold or that belong to a top fixed number of terms per message.

Server consults an importance dictionary stored as a table or configuration file that lists lexical items corresponding to high urgency or importance (for example, equivalents of “urgent”, “deadline”, or “confirmation required”). Server performs string or normalized-form matching between feature terms and dictionary entries and sets binary flags or integer counts in the feature data structure of each message. Server stores, for each message, serialized token sequences, feature term lists, and importance-dictionary match information as analysis results in the database.

This architecture improves computer performance by precomputing reusable TF-IDF vectors and dictionary flags, which permits efficient vectorized operations in later scoring phases, reduces the volume of data that must be transmitted to a generative AI model, and lowers the overall storage footprint by retaining only selected high-value features instead of full token streams when appropriate.

3. Generative AI model configuration and cooperation via prompt sentences

Server implements a generative AI cooperation unit that formulates prompt sentences and interacts with a generative AI model through an HTTP-based API. The generative AI model is, in one embodiment, an encoder-decoder or decoder-only neural network language model comprising multiple transformer layers, each layer including multi-head self-attention sublayers and feed-forward sublayers with non-linear activation functions. The model parameters include weight matrices, bias vectors, and learned embeddings that are optimized during pre-training and optionally fine-tuning.

Server maintains an API client that serializes requests into JSON and transmits them over HTTPS to an AI service endpoint. For urgency and importance evaluation, Server constructs a prompt sentence in natural language by inserting the body data and optionally feature terms into a template. An example prompt sentence is:

“You are an assistant that evaluates the priority of business emails and chats. For the following message, rate the urgency and the importance each as an integer from 1 (low) to 5 (high), and extract three important keywords. Output the urgency, the importance, and the list of keywords in a clearly structured format. Message body:’ [MESSAGE BODY]′”

Server sets request parameters such as maximum token count and temperature (for example, a low temperature to encourage deterministic outputs). When the generative AI model processes this prompt, the model internally converts tokens to embeddings, applies stacked attention and feed-forward computations, and generates output tokens one by one based on conditional probability distributions. Although these internal details are handled by the AI service, the defined architecture ensures deterministic behavior for given inputs and parameters.

Server receives the generated text and uses a parsing routine to extract numeric urgency and importance scores and keyword lists. Server stores these values as structured fields related to each message record in the database. By centralizing this parsing and data structuring, Server reduces repeated tokenization and decision logic on Terminal and ensures that Terminal receives small, pre-processed payloads, which reduces network bandwidth consumption.

4. Emotional-state estimation configuration using machine learning and generative AI Server implements an emotional-state recognition unit that processes log data from Terminal. Terminal records, in local storage, notification display events, open events, delete events, and configuration changes with timestamps and identifiers. Terminal periodically transmits batched logs to Server. Server stores these logs in dedicated tables, indexing them by user and time.

Server uses a data processing library such as a tabular data processing framework to compute feature values for each user over a sliding time window. The feature values include at least: average notification opening delay (time difference between display and open events), non-opening rate (ratio of notifications not opened within a threshold time), quick deletion rate (ratio of notifications deleted shortly after display), number of notifications received during night time, and frequency of setting silent or do-not-disturb modes.

Server encodes these feature values into a fixed-length numerical vector and inputs the vector to a trained machine learning model. In one embodiment, the machine learning model is a feed-forward neural network with multiple fully connected layers and a softmax output layer. The network is trained offline using supervised learning on historical log data labeled with emotional states such as “focused”, “high-stress”, “relaxed”, or “fatigued”. During training, Server minimizes a cross-entropy loss function between predicted state probabilities and ground-truth labels, updating the network weights using gradient descent-based optimization (for example, stochastic gradient descent or an adaptive method). Server may apply regularization techniques and data augmentation (for example, perturbing feature values within realistic ranges) to improve generalization.

At runtime, Server loads the trained model weights into memory and computes emotional-state probabilities by forward propagation of the feature vector. Server selects the label with the highest probability as the state label. When additional robustness is desired, Server also synthesizes a short natural-language description of the log pattern and passes it to the generative AI model with a dedicated prompt sentence such as:

“Read the following summary of the user's notification operation logs and decide which emotional state (focused, high-stress, relaxed, fatigued, etc.) best describes the user at this time. Return exactly one state label. Log summary: ‘[LOG SUMMARY TEXT]“ ” Server reconciles the neural network output and the generative AI model output based on predefined rules (for example, accepting the neural network label unless the generative AI output has high confidence and differs significantly). Server writes the final state label and metadata to a user state table.

This combination of deterministic feature computation, neural classification, and generative AI support yields more stable and context-aware emotional-state estimation than rule-based heuristics or human judgment alone. Because the emotional state is computed at the system level and cached, Server can adjust notification strategies without re-querying the generative AI model for each message, thereby reducing latency and external API usage.

5. Composite priority calculation and message classification

Server implements a message classification unit that references multiple data sources. For each message, Server reads urgency and importance scores from the generative AI cooperation unit, feature values related to psychological load from the natural language processing unit (such as presence of negative sentiment terms), and the latest emotional state label from the user state information. Server also reads a notification policy record for the respective user from a policy table. The policy includes parameters such as maximum notifications per hour, permitted time ranges, and threshold values for classification. When psychological load and tone are not yet quantified, Server constructs another prompt sentence and transmits it to the generative AI model. An example is:

“Analyze the tone of the following message body and classify it as one of: ‘very negative’, ‘negative’, ‘neutral’, ‘positive’, or ‘very positive’. Also, evaluate the psychological burden this message may cause to the receiver as an integer from 1 (low) to 5 (high). Message body:

### ‘[MESSAGE BODY]’”

Server parses the response to obtain a tone label and a numerical psychological load score and stores them as additional features.

Server then executes a composite scoring function that combines all features. In one embodiment, Server computes:
composite_priority=w1 ×urgency_score+w2 ×importance_score+w3 ×tone_weight+w4×dictionary_flag_score-w5 ×psychological_load_modifier, where the weights w1-w5 depend on the emotional state and user policy. For example, in the “focused” state, Server increases w1 to prioritize time-critical content; in the “high-stress” state, Server increases w5 to penalize high-burden messages. Server also queries the database to count notifications already sent within a recent time interval and applies additional penalties to composite_priority if the count exceeds a policy limit.

By expressing composite priority as a deterministic numeric function of standardized features, Server converts heterogeneous contextual data into a single ordering metric that is efficiently comparable and sortable. Server then classifies each message by comparing composite priority against configurable thresholds. If composite_priority is above a first threshold, Server sets the classification to an immediate notification target. If composite_priority is between first and second thresholds, Server sets the classification to a delayed notification target. If composite_priority is below the second threshold, Server sets the classification to a summary target. Server saves the classification result and composite priority into the message record.

This algorithmic design improves machine-level scheduling of notifications, enabling Server to allocate processor time and network resources to higher-impact messages and to defer or aggregate less critical communication, directly optimizing computational and communication efficiency.

6. Notification Generation with Generative AI-Assisted Neutral Summaries

Server implements a notification generation unit that constructs compact notification payloads and outputs them to Terminal. For each message classified as an immediate or delayed notification target, Server retrieves body data, sender information, composite priority, and user emotional state. Server determines a notification title, for example, “New message from [sender]”.

When the user emotional state indicates high stress, Server constructs a prompt sentence instructing the generative AI model to create a neutral, low-pressure summary. An example prompt sentence is:

“Summarize the following email into a single sentence in a neutral tone that does not put excessive pressure on the recipient. Keep explicit information about deadlines and required actions. Email body: ‘[EMAIL BODY]’”

Server transmits this prompt sentence and original text to the generative AI model, receives a one-sentence summary, and uses this summary as notification content. If the user state is not high stress, Server may instead truncate the original body data to a fixed number of characters and use this as notification content.

Server then constructs a notification information object containing at least the title, body text (summary or truncated content), message identifier, and priority indicators. Server transmits this object via a push-notification infrastructure or HTTPS endpoint to Terminal. Terminal invokes an operating-system-level notification interface to present the notification on the display, and optionally triggers sound or vibration based on local or server-supplied parameters.

Because Server selectively offloads text generation to the generative AI model only when linguistic tone adaptation is beneficial, the system reduces redundant API calls while still leveraging the model for complex generation tasks that would be difficult to implement with static templates. This improves both responsiveness and quality of notifications, and reduces the likelihood of user overload and subsequent manual configuration adjustments.

### 7. Summary Generation Using Topic-Organized Outputs

Server implements a summary generation unit to aggregate messages classified as summary targets. Server groups such messages by user and time period (such as daily) by executing database queries with conditions on classification type and timestamps. For each group, Server concatenates body data and attaches sender information, optionally marking each message with separators.

Server constructs a summary-oriented prompt sentence, for example:

“The following are multiple work-related messages received today. Read them and summarize today's work activity so that the user can quickly understand the overall situation. Group the summary by important topics as bullet points, and add the related sender name to each topic. Output in Japanese as about 5 to 8 lines. Message list: ‘[MESSAGE 1]’ ‘[MESSAGE 2]’ . . . ”

Server sends this prompt and the concatenated content to the generative AI model, receives topic-organized summary text, and stores the result in a summary table with fields for user identifier, date, summary text, and included message identifiers. Terminal retrieves summary entries via an API, displays them on a dedicated dashboard screen, and allows User to browse daily or periodic digests. Terminal logs summary view events and any user feedback (such as “helpful” or “not useful”) and transmits this data back to Server to support further fine-tuning of policies or model parameters.

By performing aggregation server-side, and by sending only condensed summary outputs to Terminal, the system reduces the number of notifications and the volume of message data that must be transmitted to and rendered on user devices. This structure therefore reduces communication load and client-side resource consumption.

### 8. Notification Policy Adjustment Via Generative AI

Server maintains a notification policy for each user and updates it based on operation logs and explicit feedback. When User changes preferences in the Terminal interface or submits free-text feedback such as “notifications are too frequent at night”, Terminal transmits structured feedback data to Server. Server retrieves recent notification and emotional-state statistics, and synthesizes a natural-language log summary and feedback summary.

Server constructs a policy-oriented prompt sentence, for example:

“Read the following summary of the user's notification operation logs and the feedback content, and propose an optimal notification policy for this user. The policy should include maximum number of notifications per hour, whether notifications are allowed during the night (22:00-7:00), and threshold values that determine when to send an immediate notification versus deferring to summary. Operation log summary: ‘[LOG SUMMARY]’ Feedback summary: ‘[FEEDBACK SUMMARY]”

Server transmits this prompt to the generative AI model and receives proposal text containing numeric parameters and conditions. Server parses this text to extract candidate values for maximum notifications per hour, night notification permissions, and threshold levels. Server stores proposed values in the policy table with a flag indicating pending user confirmation. Terminal fetches the proposed policy and displays it in an editable settings screen, allowing User to accept or modify the values before they become active. After confirmation, Server activates the new policy values and uses them in subsequent composite-priority calculations. This embodiment uses the generative AI model not simply as a replacement for human decision-making, but as a computational tool that can infer reasonable configuration parameters from complex historical patterns. Since the derived parameters are injected directly into numeric computation routines, the system achieves automated tuning that would be infeasible with static rule-sets or manual configuration alone, thereby improving long-term efficiency and accuracy of notification scheduling.

### 9. Technical Effects and Variations

Server improves computer technology itself rather than merely automating human judgment. The system reduces redundant and low-value notifications, thereby reducing processor wakeups on Terminal, decreasing network traffic, and lowering battery consumption. By structuring data into message records, feature vectors, state labels, and policies, Server enables indexed queries and vectorized operations that are more efficient than ad hoc text scanning. The composite-priority algorithm ensures that expensive external model calls are limited to messages where nuanced evaluation add significant value, thus optimizing API usage and throughput.

Because the generative AI model is invoked with carefully designed prompt sentences and controlled parameters, its outputs are transformed into deterministic, machine-readable data that is integrated into the system's workflows. The emotional-state recognition model uses non-intuitive feature combinations (such as correlations among open delay, deletion patterns, and time-of-day distribution) that differ from conventional human heuristics, enabling improved prediction accuracy and more responsive adaptation.

Alternative embodiments may employ different neural network architectures for emotional-state classification, such as recurrent neural networks or attention-based models, different optimization methods, or different feature sets derived from logs. Alternative generative AI providers or locally deployed generative models may be used, provided that Server maintains the prompt-sentence interface and structured-output parsing described above. The relational database may be replaced by a key-value store or document database while preserving the logical structure of message records and state data. The composite-priority function may be implemented as a trainable model instead of a fixed formula, as long as Server continues to base classification decisions on explicit numeric features derived from message content, user state, and notification policies.

In all such variations, Server, Terminal, and User interact through defined protocols and data structures so that the system can be realized by one of ordinary skill in the art without undue experimentation, and the technical effects of improved notification precision, reduced computational overhead, and enhanced utilization of generative AI and machine learning models are achieved.

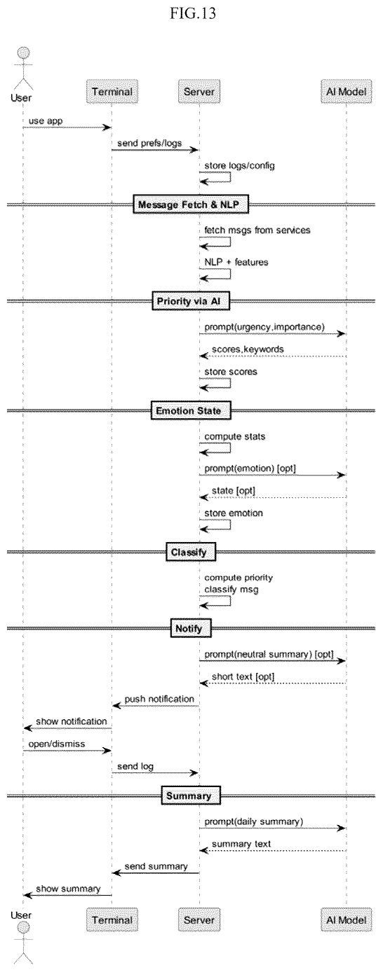

The following describes the processing flow using FIG. 13.

### Step 1:

Server acquires and normalizes electronic messages.

Server receives as input service connection settings stored in a configuration table, including service type, endpoint URL, authentication credentials, and retrieval parameters such as folders or channels. Server uses a mail access library with IMAP or POP3 to connect to email servers and an HTTP client library to send HTTPS requests to chat or enterprise messaging APIs. Server parses protocol responses and JSON payloads, extracts fields such as message ID, sender, recipient, body text, and timestamps, and performs data conversion such as character-set decoding and time-zone normalization. Server then constructs unified message records with standardized fields and writes them into a message table in a relational database.

The output of this step is a set of normalized message records marked with a “new” processing status.

### Step 2:

Server performs natural language processing and feature extraction.

Server takes as input the body text and metadata of message records whose status is “new”. Server loads a morphological analyzer and passes each body text string to the analyzer to obtain a token sequence with part-of-speech tags. Server filters tokens by part of speech to remove low-information tokens and retains content-bearing tokens. Server groups token sequences from multiple messages and uses a TF-IDF vectorizer to compute term-frequency and inverse-document-frequency statistics. Based on these statistics, Server calculates TF-IDF scores for each token and selects feature terms with high scores. Server compares feature terms with entries in an importance dictionary and sets match flags and counts. Server then stores token sequences, feature term lists, and importance-dictionary match information back into the message records and updates their status to “NLP_processed”. The output of this step is a set of message records with enriched linguistic feature data.

### Step 3:

Server evaluates urgency and importance using a generative AI model.

Server uses as input the body text and NLP feature data (such as feature terms and dictionary flags) from message records in status “NLP_processed”. Server constructs a prompt sentence by inserting the message body, and optionally detected keywords, into a pre-defined template. For example, Server may generate the following prompt sentence:

“You are an assistant that evaluates the priority of business emails and chats. For the following message, rate the urgency and the importance each as an integer from 1 (low) to 5 (high), and extract three important keywords. Output the urgency, the importance, and the list of keywords in a clearly structured format. Message body:’ [MESSAGE BODY]” Server sends the prompt sentence to a generative AI model via an HTTPS-based API and sets parameters such as temperature and maximum token count. Server receives the generated text response, parses it using string operations or regular expressions to extract numeric urgency and importance scores and keyword lists, and validates the values against allowed ranges. Server writes the scores and AI-extracted keywords into the message records and sets their status to “priority_scored”. The output of this step is a set of message records with urgency and importance scores linked to each message.

### Step 4:

Terminal records notification and operation events and uploads logs.

Terminal receives as input notification information objects sent by Server, including message identifiers, titles, bodies, and priority indicators. Terminal calls the operating system's notification API to display notifications on the display and optionally play sounds or vibrations. Terminal logs a notification display event with fields such as event type, message ID, and display time. When User taps a notification, Terminal opens a message detail view and records an open event with an open timestamp. When User dismisses a notification, Terminal records a delete event. When User changes notification-related settings, Terminal logs configuration-change events. Terminal batches accumulated events into a log payload and periodically sends the payload to Server via HTTPS. The output of this step is a set of notification and operation log records transmitted from Terminal to Server.

### Step 5:

Server computes behavioral features and estimates user emotional state.

Server takes as input the notification and operation logs uploaded by Terminal for each user over a recent time window. Server uses a data processing library to group logs by user and compute feature values such as average open delay, non-open rate, quick delete rate, number of notifications in specific time ranges, and frequency of silent-mode changes. Server encodes these feature values into fixed-length numerical vectors and feeds each vector into a pre-trained neural network classifier. The classifier performs forward propagation to produce probability scores for emotional-state labels such as “focused”, “high-stress”, “relaxed”, and “fatigued”. Server selects the label with the highest probability. Optionally, Server also generates a text description of the logs and sends a prompt sentence such as: “Read the following summary of the user's notification operation logs and decide which emotional state (focused, high-stress, relaxed, fatigued, etc.) best describes the user at this time. Return exactly one state label. Log summary: ‘[LOG SUMMARY TEXT]’” to the generative AI model and receives a suggested label. Server reconciles both outputs according to predefined rules and stores the final emotional-state label and timestamp as user state information. The output of this step is a current emotional-state label for each user.

### Step 6:

Server calculates composite priority and classifies messages.

Server uses as input the urgency and importance scores from the generative AI model, the NLP-derived features including dictionary flags and sentiment-related terms, the psychological load information if already available, the user's latest emotional state, and the user's notification policy. When psychological load and tone are missing, Server constructs and sends a prompt sentence such as:

“Analyze the tone of the following message body and classify it as one of: ‘very negative’, ‘negative’, ‘neutral’, ‘positive’, or ‘very positive’. Also, evaluate the psychological burden this message may cause to the receiver as an integer from 1 (low) to 5 (high). Message body:

### ‘[MESSAGE BODY]’”

to the generative AI model and parses the response to acquire a tone label and a psychological load score. Server then performs a numeric computation combining urgency score, importance score, tone information, dictionary-based scores, psychological load, and emotional-state-dependent weights to derive a composite priority value for each message. Server also queries recent notification counts to apply penalties if the number of notifications exceeds policy limits. Based on the resulting composite priority and policy thresholds, Server classifies each message into an immediate notification target, a delayed notification target, or a summary target. Server updates the message records with composite priority values and classification types. The output of this step is a classified message set with assigned notification categories.

### Step 7:

Server generates notification content using the generative AI model when necessary and sends notifications.

Server takes as input message bodies, sender information, classification types, composite priority scores, and emotional-state labels for messages classified as immediate or delayed notification targets. Server constructs a notification title from sender or subject fields. If the emotional state indicates high stress or if a policy requires softened tone, Server creates a prompt sentence such as:

“Summarize the following email into a single sentence in a neutral tone that does not put excessive pressure on the recipient. Keep explicit information about deadlines and required actions. Email body: ‘[EMAIL BODY]’” and sends it to the generative AI model. Server receives a one-sentence summary, checks its length and basic structure, and uses it as notification body content. Otherwise, Server truncates the original message body to a predetermined length and uses that text as the notification body. Server composes a notification information object containing title, body, message identifier, and priority markers and transmits this object to Terminal via HTTPS or a push-notification service. The output of this step is a stream of notification information objects delivered to Terminals.

### Step 8:

Server aggregates summary-target messages and generates summary information.

Server uses as input message records classified as summary targets, including their body data, sender information, and timestamps. Server groups messages by user and period (for example, per day) by querying the database with conditions on classification type and time range. For each group, Server concatenates the message texts and associates sender names, inserting delimiters between messages. Server constructs a prompt sentence such as:

“The following are multiple work-related messages received today. Read them and summarize today's work activity so that the user can quickly understand the overall situation. Group the summary by important topics as bullet points, and add the related sender name to each topic. Output in Japanese as about 5 to 8 lines. Message list: ‘[MESSAGE 1]’ ‘[MESSAGE 2]’ . . . ” and sends this text to the generative AI model. Server receives a multi-line summary, verifies its structure, and stores it in a summary table with user ID and period information. The output of this step is a set of summary records that represent aggregated digest information for later user review.

### Step 9:

Terminal presents notifications and summaries and records user feedback.

Terminal takes as input notification information objects from Server and summary information retrieved from a summary API. Terminal uses the operating system's notification interface to display notifications with title and body text, and records user interactions as described earlier. For summaries, Terminal fetches summary entries for a specified user and date range, renders them in a dashboard-style user interface, and allows User to select a date to view the corresponding summary text. Terminal may present feedback options such as “helpful” or “not useful”; when User selects an option, Terminal creates a feedback record including summary identifier, user choice, and timestamp, and uploads it to Server. The outputs of this step are displayed notifications and summaries on Terminal and a set of feedback and viewing-log records transmitted to Server.

### Step 10:

User adjusts notification preferences and Server updates notification policies via the generative AI model.

User uses Terminal's settings screen as input to specify preference data, including options such as maximum acceptable notification frequency, nighttime notification restrictions, and free-text comments about notification burden. Terminal converts these preferences into structured feedback and sends them to Server. Server retrieves recent notification and emotional-state statistics and generates textual summaries of logs and feedback. Server constructs a policy-oriented prompt sentence such as:

“Read the following summary of the user's notification operation logs and the feedback content, and propose an optimal notification policy for this user. The policy should include maximum number of notifications per hour, whether notifications are allowed during the night (22:00-7:00), and threshold values that determine when to send an immediate notification versus deferring to summary. Operation log summary: ‘[LOG SUMMARY]’ Feedback summary: ‘[FEEDBACK SUMMARY]“ ” and sends it to the generative AI model. Server receives policy proposal text, parses numeric values and conditions, and writes proposed policy parameters to the policy table with a pending status. Terminal retrieves these proposals, displays them to User, and allows modifications. After User confirms, Terminal sends updated parameters back to Server. Server finalizes the notification policy records and uses the updated parameters as input in subsequent composite-priority calculations and message classifications. The output of this step is an updated set of user-specific notification policies stored on Server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In modern work environments, such as logistics sites, manufacturing sites, and sales sites, workers and supervisors receive a large volume of fragmented business messages from heterogeneous information processing systems, including electronic mail systems, messaging systems, and business management systems. Conventional notification systems typically classify and filter messages using keyword-based or rule-based logic and then deliver notifications in a uniform manner, regardless of the worker's current cognitive state or emotional load. As a result, several technical problems arise in computer-based information delivery.

First, existing systems lack a unified computational mechanism to integrate messages across multiple independent platforms into a normalized representation and to jointly evaluate urgency and importance using context-aware natural language processing. The underlying data processing pipelines treat messages as isolated text strings and do not exploit advanced language models and accumulated feedback to improve the quality of urgency and importance scoring. This leads to ineffective prioritization logic implemented in software, which causes the notification subsystem of the computer system to overload the user interface with low-value alerts and to omit or delay truly critical information.

Second, conventional systems do not incorporate a robust, machine-executable model of the emotional or stress state of senders and receivers into the core notification decision logic. In typical architectures, user state, if considered at all, is represented by static preferences or coarse “do-not-disturb” settings. There is no integrated component that uses a generative AI model, driven by explicit prompt sentences, to estimate emotion categories and strengths from message content, and to combine those estimates with fine-grained operation history logs and work data to infer a receiver's stress level. Consequently, the notification and summarization algorithms executed by the processor are blind to the user's real-time cognitive capacity, leading to degraded human-computer interaction, increased error rates, and inefficient usage of computing and network resources, for example by transmitting and rendering content that the user is not in a position to process effectively.

Third, existing systems provide only static prompt designs and fixed templates when invoking external or internal generative AI models, if they use such models at all. They do not include a closed-loop learning mechanism in which the processor collects per-message and per-summary feedback, associates such feedback with corresponding message features and emotion information, and then updates both prediction models (for urgency, importance, and stress) and prompt sentence templates. This absence of adaptive prompt and model refinement reduces the accuracy and stability of the end-to-end computation performed by the system over time, and prevents the system from converging to behavior that is tuned to the specific task domain, organization, or individual user.

Fourth, typical systems separate natural language analysis, emotion estimation, and notification rendering into loosely connected subsystems, without a unified control flow that treats them as a single computational pipeline. As a result, they cannot dynamically select between immediate notification and later summary generation based on a coherent combination of message semantics, predicted urgency and importance, and real-time user state. This fragmented design leads to redundant or inconsistent data processing, increases latency, and complicates the implementation of consistent policies in distributed computing environments.

Accordingly, there is a need for a computer-implemented information presentation system whose processor is configured to: (i) normalize messages from multiple heterogeneous information processing apparatuses; (ii) evaluate urgency and importance using advanced natural language processing; (iii) estimate emotional state and stress level using a generative AI model driven by structured prompt sentences and enriched with operation history and work data; and (iv) dynamically control notification and summary generation policies based on these evaluations, while continuously updating internal models and prompt templates based on user feedback. Addressing these problems constitutes an improvement in the functioning of the computer system itself, including its data processing pipeline, its interaction with external generative AI services, and its notification and summarization subsystems, rather than merely automating a human mental process.

The specific processing by the specific processing unit 290 of the data processing device 12 in Application Example 2 is realized by the following means.

The present invention provides a server comprising a processor and a memory storing instructions which, when executed by the processor, cause the processor to acquire business-related messages from a plurality of external information processing apparatuses, convert the acquired messages into an internal common format, and store the converted messages as normalized message data; to perform natural language processing on character information included in each normalized message, including at least tokenization, structural analysis, and semantic feature extraction, and to evaluate an urgency and an importance of each message as numerical scores using a trained prediction model based on both lexical features and sentence representations; to construct, for each message, a prompt sentence that includes at least the message character information and context information, to input the prompt sentence to a generative AI model, and to estimate an emotional state of a sender or a receiver of the message by parsing an output of the generative AI model and generating emotion information comprising at least an emotion category and a strength of the emotion category; to compute or update, for each receiver, a stress level by inputting, to a machine learning model, features derived from at least the emotion information, operation history information collected from an information presentation apparatus, and work data representing a working condition, and to determine, for each message, a notification policy based on at least the urgency, the importance, the emotion information, and the stress level, the notification policy specifying whether the message is to be presented as an immediate notification or as a later-view summary and specifying at least a presence or absence, a timing, a content, and an expression format of the notification; to generate, for messages designated as immediate notification targets, notification information including a basic notification content and a supplementary explanation by constructing a prompt sentence adapted to at least one of the emotional state and the stress level of the receiver, inputting the prompt sentence to the generative AI model, obtaining the supplementary explanation from the generative AI model, combining the supplementary explanation with the basic notification content, and transmitting the notification information to the information presentation apparatus; to generate, for messages designated as non-immediate notification targets, summary information by grouping a plurality of such messages based on at least message attributes, constructing a prompt sentence that reflects at least one of the user's stress level and a desired summary length or tone, inputting the prompt sentence and the grouped messages to the generative AI model, obtaining a summary output from the generative AI model, and storing and providing the summary output to the information presentation apparatus for later viewing; and to collect, from the information presentation apparatus, operation history information and feedback information provided by a user regarding at least the notification information and the summary information, to associate the collected information with corresponding messages and emotion information to form training data, and to update at least one of the prediction model for evaluating the urgency and the importance, the machine learning model for estimating the stress level, and one or more templates of the prompt sentences supplied to the generative AI model, based on the training data. This enables the computer system to improve its internal data processing and decision-making pipeline by dynamically integrating semantic analysis, emotion and stress estimation, and user feedback into the notification and summarization logic, thereby reducing unnecessary or ill-timed notifications, enhancing the relevance and readability of generated content, and adaptively optimizing both predictive models and generative AI prompt sentences over time.

The term “business-related message” refers to electronic message data representing information about business activities, including at least a sender identifier, a receiver identifier, a transmission time, and a body text, and optionally including additional metadata such as channel information, task identifiers, or category labels.

The term “external information processing apparatus” refers to a computing apparatus that executes an application for managing or transmitting messages, such as an electronic mail system, a messaging system, or a business management system, and that is connected to the server via a communication network.

The term “internal common format” refers to a normalized data structure defined within the server, to which heterogeneous message data acquired from different external information processing apparatuses are converted so that the messages can be processed uniformly by subsequent modules.

The term “normalized message data” refers to message records that have been converted from raw message data of the external information processing apparatuses into the internal common format and stored in a memory of the server.

The term “natural language processing” refers to automated processing of human language text by the processor, including at least tokenization, morphological analysis, syntactic analysis, semantic feature extraction, and generation of numerical or symbolic representations suitable for machine learning models.

The term “urgency” refers to a numerical measure representing a degree of time-criticality of a business-related message, as evaluated by a prediction model based on features derived from the message content and context.

The term “importance” refers to a numerical measure representing a degree of potential impact of a business-related message on an organization, a process, or a user, as evaluated by a prediction model based on features derived from the message content and context. The term “prediction model” refers to a computational model, such as a machine learning model or a statistical model, that receives feature data as input and outputs at least a numerical score for urgency, importance, or another target quantity.

The term “sentence representation” refers to a numerical vector that encodes semantic information of a message or sentence, obtained by applying a pre-trained language representation model to the message text.

The term “pre-trained language representation model” refers to a machine-learned model trained in advance on a large corpus of text data to generate contextualized vector representations of input text segments, and which can be used as a feature generator for downstream tasks.

The term “prompt sentence” refers to a text string that contains instructions, constraints, or examples, and that is supplied as input to a generative AI model in order to specify a desired output format, content, length, tone, or processing objective.

The term “generative AI model” refers to a machine learning model, such as a large language model, configured to generate text, summaries, classifications, labels, or other outputs in response to an input prompt sentence and optional additional input data.

The term “emotion information” refers to information representing an estimated psychological state of a sender or a receiver of a message, including at least one emotion category, such as anger, anxiety, confusion, fatigue, or normal, and a numerical strength value associated with each emotion category.

The term “emotional state” refers to a qualitative or quantitative representation of a psychological or affective condition of a person, such as anger, anxiety, confusion, fatigue, calmness, or the like, as estimated by processing message content and contextual data. The term “stress level” refers to a numerical score representing an estimated degree of mental or cognitive load of a receiver, derived from features including emotion information, operation history information, and work data.

The term “operation history information” refers to log data generated by an information presentation apparatus that records user interactions, including at least notification viewing times, notification mute or dismissal events, misoperation counts, and screen transition patterns.

The term “work data” refers to data representing conditions of a user's work environment or schedule, including at least working time information, overtime information, and break acquisition status.

The term “notification policy” refers to a set of rules or parameters determined for each message based on urgency, importance, emotion information, and stress level, the rules specifying at least whether the message is to be presented as an immediate notification or as a summary, and how, when, and in what format the notification is to be presented. The term “immediate notification” refers to a notification that is scheduled to be presented to the user without substantial delay after a determination by the processor that the corresponding message meets predetermined conditions.

The term “later-view summary” refers to summary information generated from one or more messages and intended to be presented to the user at a time different from the original receipt time of the messages, such as at a periodic or user-selected time.

The term “basic notification content” refers to a core part of notification information derived directly from the original message data, including at least a title, a condensed body text, and essential metadata.

The term “supplementary explanation” refers to additional explanatory text generated by the generative AI model based on a prompt sentence, the text being adapted to at least one of the receiver's emotional state or stress level to make the message easier to understand or less burdensome to read.

The term “information presentation apparatus” refers to an electronic apparatus used by a user to receive and interact with notifications and summaries, such as a mobile terminal, a tablet, a personal computer, or a dedicated terminal with a display and an input interface.

The term “summary information” refers to information generated from a plurality of messages, where the information condenses and abstracts the messages into a shorter text that highlights key points and may be adapted in length and tone according to the user's state. The term “grouping and summarization processing” refers to processing in which messages are grouped according to one or more attributes, such as category, time, or recipient, and condensed using algorithmic or generative methods to produce summary information. The term “feedback information” refers to information explicitly provided by a user in response to notification information or summary information, including at least importance evaluations, response completion indicators, and assessments of clarity or conciseness. The term “training data” refers to data sets formed by associating input features, such as message features, emotion information, operation history information, and work data, with target labels or metrics derived from feedback information, and used for training or updating one or more models executed by the processor.

The term “prompt sentence template” refers to a parameterizable pattern of a prompt sentence, including placeholders for message text, context, or instructions, which is stored and programmatically instantiated by the processor to generate concrete prompt sentences supplied to the generative AI model.

The term “update of a model” refers to an operation in which parameters of a prediction model, a machine learning model, or another computational model are modified based on training data, such as by retraining, fine-tuning, or incremental learning.

The term “update of a prompt sentence template” refers to an operation in which the content, structure, or constraint conditions of a stored prompt sentence template are changed based on analysis of feedback information or model performance, so as to improve outputs generated by the generative AI model.

In the following embodiments, a server, a terminal, and a user implement the invention. The same reference architecture can be realized using various hardware and software platforms as described below.

Server uses a general-purpose computer system equipped with at least one processor, a main memory, an auxiliary storage device, and a network interface. Server executes an operating system such as a server-class operating system (for example, a general-purpose UNIX-like operating system) and runs an application server, a database management system, and optional message queue middleware on top of the operating system. Server stores executable programs and configuration data for the functions described below in the auxiliary storage device and loads them into the main memory to be executed by the processor.

Terminal uses an information processing apparatus such as a smartphone, a tablet device, or a personal computer, and executes either a native mobile application or a web browser. Terminal communicates with server via a packet-switched communication network. Terminal includes a display unit, an input unit such as a touch panel or a pointing device, and a local storage for caching received data.

User operates terminal in a logistics site, a manufacturing site, a sales site, or similar environment, and interacts with notifications and summaries that are generated by server.

1. Hardware and software configuration

Server uses a multi-core microprocessor as the processor, a semiconductor memory as the main memory, and a semiconductor storage or magnetic storage as the auxiliary storage. Server uses a database management system such as a relational database management system to store normalized message data, feature data, model parameters, emotion information, and user feedback. Server optionally uses an in-memory cache such as a key-value store to speed up frequent reads of user state or configuration data.

Server uses a message queue system to decouple acquisition of messages from downstream natural language processing and model inference. For natural language processing and model training/inference, server uses machine learning libraries such as a tensor computation framework and an associated neural network library. Server optionally uses a transformer model library to handle pre-trained language representation models and generative AI models. Terminal uses an operating system such as a mobile operating system or a desktop operating system and uses the platform's notification framework to show push notifications. Terminal runs a client application that communicates with server via a secure protocol such as HTTPS. Terminal records user interaction events locally and forwards them to server.

### 2. Message Normalization and Internal Data Structures

Server acquires business-related messages from a plurality of external information processing apparatuses such as an electronic mail system, an enterprise messaging system, and a business management system. Server uses connection interfaces such as RESTful APIs or message feeds provided by these external apparatuses. Server stores authentication credentials and endpoint information in configuration files or configuration tables.

Server receives responses in heterogeneous formats (e.g., different JSON or XML schemas) and converts them into an internal common format. Server defines, for example, an internal message record with at least the following fields:
message_id: a unique identifier generated by server,
source_system: a code representing the external apparatus,
sender_id: a normalized identifier of the sender,
receiver_id: a normalized identifier of the receiver,
timestamp: a standardized time representation,
text: the message body as plain text,
channel: a normalized category or channel,
metadata: a structured field containing additional attributes.

Server stores these records in a database table dedicated to normalized messages. Server indexes this table by at least message_id, receiver_id, and timestamp to support efficient retrieval in downstream processing. Because server enforces a unified schema, subsequent modules operate over a homogeneous data structure, which reduces data conversion overhead and improves processing throughput.

3. Natural language processing and urgency/importance scoring

Server performs natural language processing on the text field of each normalized message. Server uses a morphological analysis library (for example, a general-purpose tokenization and part-of-speech tagging library for the target language) to split the message text into tokens and annotate part-of-speech tags. Server additionally computes syntactic and semantic features by passing the tokenized text to a pre-trained language representation model, such as a transformer-based encoder that outputs a dense sentence representation for each message. Server constructs a feature vector for each message by concatenating:
bag-of-words or n-gram features derived from the tokens,
binary or count features indicating presence and frequency of domain-specific keywords (e.g., “urgent”, “shipment stop”, “trouble”),
numeric features such as message length, number of exclamation marks, etc.,
the dense sentence representation produced by the pre-trained language representation model.

Server inputs this feature vector into a prediction model that outputs an urgency score and an importance score. In one embodiment, server uses a feed-forward neural network (multi-layer perceptron) with several fully connected layers, non-linear activation functions (e.g., rectified linear units), and an output layer that predicts continuous scores. Server trains this network off-line using supervised learning, with labeled data constructed from historical messages and human-provided labels of urgency and importance. Server defines a loss function such as mean squared error over the predicted scores and the ground truth labels, and server uses gradient descent with backpropagation to update model weights.

By using a dense sentence representation from a transformer encoder in combination with lightweight feed-forward layers, server reduces computation time per message compared to running a full generative model, and server improves the accuracy of urgency and importance predictions compared to simple keyword-based methods. This approach yields a technical effect of improving prioritization quality and reducing the volume of low-value notifications transmitted to terminals.

4. Emotion estimation via generative AI model and prompt sentences

Server estimates an emotional state associated with each message by invoking a generative AI model using a carefully constructed prompt sentence. Server constructs a prompt sentence that includes at least:
an instruction part in a natural language,
a description of the desired output format,
the target message text as quoted text,
optionally, contextual messages and metadata (e.g., preceding messages in a conversation).

For example, server generates a prompt sentence such as:
“Read the following Japanese business message and estimate the sender's emotional state. Output JSON with keys ‘anger’, ‘anxiety’, ‘urgency’, ‘confusion’, ‘fatigue’, and ‘normal’, each from 0 to 5.

Message: “Urgent: Please ship 50 cases of Product A by 5:00 PM today. The customer has already filed a complaint.”

In the actual implementation, server does not require JSON in the output for the purposes of the claims, but this example illustrates the format guidance given in the prompt sentence.

Server forwards this prompt sentence, along with configuration parameters such as generation temperature and maximum output length, to a generative AI model. Server may use:
an external large language model service accessed via an API, or
a local generative model instance deployed on server hardware, such as a transformer-based decoder-only network.

In the local deployment case, server loads a transformer-based language model with multiple layers of self-attention, feed-forward sublayers, layer normalization, and positional encodings. Server executes the model by applying the attention and feed-forward blocks to tokenized prompt sequences and then decoding output tokens using a probability distribution over the vocabulary.

Server receives the generated output text, which contains emotion categories and numeric scores, and parses it to extract individual emotion scores (anger, anxiety, urgency, confusion, fatigue, normal). Server stores these scores as emotion information associated with the message and with the corresponding user. The use of a generative AI model here differs from simple rule-based pattern matching because the model captures subtle semantic and pragmatic cues in the text; this allows server to estimate an emotional state even for messages that do not contain explicit emotion-related keywords, which yields higher coverage and accuracy.

5. Stress level estimation using operation history and work data

Terminal records granular operation history information when user interacts with notifications and summaries. For example, terminal records:
the time at which a notification arrives,
the time at which user opens the notification,
the duration for which the content is visible on the screen,
events such as “mute notification”, “dismiss notification”, “delay handling”,
misoperation events such as repeated back-and-forth navigation or accidental taps,
scrolling distances and speeds on content views.

Terminal batches this information into event logs and periodically transmits them to server. Server also obtains work data such as working time, overtime hours, and break intervals from other systems or from terminal.

Server aggregates these data per user over a sliding time window and constructs a feature vector that includes:
statistical measures of reading time (average, variance),
frequency of notification muting or dismissal,
misoperation rate,
total active work time within the window,
time elapsed since the last recorded break.

Server inputs this feature vector into a machine learning model for stress estimation. In one embodiment, server uses a regression model such as a deep neural network with fully connected layers and a final output neuron representing a continuous stress level score. Server trains this model using labeled datasets where approximate ground truth stress levels are derived from questionnaires, supervisor assessments, or specific events such as formal breaks or end-of-shift evaluations.

Server defines a loss function such as mean squared error between predicted and ground truth stress levels and applies gradient-based optimization to update model weights. Server may use data augmentation techniques like random noise injection into non-critical features, or sub-sampling of events to improve model robustness.

By computing stress levels automatically from operation history and work data, server adjusts information delivery based not only on message content but also on current user capacity, which improves the technical performance of the notification system by reducing unnecessary rendering and network usage during high-stress periods.

### 6. Notification Policy Determination and Dynamic Control

Server integrates urgency scores, importance scores, emotion information, and stress levels to determine a notification policy for each message. Server encodes this policy as a record containing:
notification_type: immediate, delayed, or summary-only,
recommended_disposition_time: an estimated time at which the notification should be presented,
presentation_mode: e.g., popup, silent notification, summary line,
verbosity: e.g., full explanation, brief explanation.

Server uses a set of rules or a learned policy model to compute these fields. In one embodiment, server implements a rule engine that evaluates conditions such as:
(urgency >=high_threshold AND importance >=high_threshold AND stress <moderate_threshold)->immediate notification with detailed explanation,
(urgency in [medium, high) AND stress >=high_threshold)->delayed notification with shortened explanation,
(urgency <medium AND importance <medium)->summary-only.

Server optionally uses a reinforcement learning or contextual bandit approach to optimize these rules, but even in a rule-based embodiment, the rules are applied over rich, algorithmically produced scores and emotion metrics, not over static user preferences.

By calculating notification policy on server-side and encoding it explicitly, server reduces unnecessary notifications during high load and ensures that critical messages are delivered promptly when the receiver is most likely to be able to respond. This yields a technical effect of reducing bandwidth consumption from server to terminal and lowering the number of graphics rendering operations on terminal.

### 7. Generation of Tailored Notifications and Supplementary Explanations

Server generates notification information for messages designated as immediate notification targets. Server constructs a basic notification content from the original message, for example:
a title extracted from or derived from the message body,
a condensed preview of the body text,
metadata such as source system and category.

If server detects that the receiver has a high confusion or anxiety score or a high stress level, server also generates a supplementary explanation. Server constructs a prompt sentence containing the original instruction and a guideline on how to rewrite it. For example: “You are an assistant for logistics workers.

Rewrite the following Japanese instruction so that a new worker can understand it easily.

Describe the actions in exactly 3 numbered steps.

Avoid technical terms and keep each sentence short and clear.

Instruction: “Please ship 50 cases of Product A by 5:00 PM today. Pick Product A from Shelf A-12 in Zone A, transport it to the inspection line in Area B, and then attach Label L-01.” Server sends this prompt sentence to the generative AI model and receives a set of step-by-step instructions. Server performs simple rule-based post-processing (e.g., limiting total character count, ensuring presence of numbering “1.”, “2.”, “3.”) to ensure rendering consistency on terminal. Server then appends this supplementary explanation to the basic notification content.

By generating tailored supplementary explanations only for users in specific emotional or stress states and by constraining the length and structure of the generated text, server reduces cognitive load on user while limiting the volume of generated text that must be transmitted and rendered. This results in a concrete improvement in data transfer efficiency and user-interface responsiveness.

### 8. Summary Generation for Low-Priority Messages

Server generates summary information for messages that are determined to be summary-only. Server groups messages by attributes such as category, time of day, or project ID. For each group, server constructs a prompt sentence that instructs the generative AI model how to summarize. For example:

“Summarize the following Japanese business messages about today's warehouse operations.

The reader is under stress, so use calm and reassuring language.

Extract only the 3 most important points and output them as 3 bullet points in Japanese.

Messages:
1. “As a result of the inventory count conducted this afternoon, we found that two cases of Product B are missing.′
2. “Following an inquiry from the shipper, we confirmed one labeling error in yesterday's shipment.”
3. “We will hold an orientation session tomorrow morning to explain the new picking rules.”

Server receives the summary text from the generative AI model, verifies that the expected number of bullet points is present, and, if necessary, truncates or reformats the text. Server stores summaries in association with user and date, and preloads them into cache shortly before predicted viewing times.

Because server performs grouping and summarization centrally with knowledge of all messages and user state, summary generation reduces the number of individual message notifications and reduces the volume of text that needs to be communicated to terminal. This yields an improvement in communication efficiency and storage utilization on terminal.

### 9. User Interaction Logging and Feedback Collection

Terminal presents notifications and summaries using the platform's notification framework and application UI. User opens notifications, reads content, and taps control elements such as “Mark as Important”, “Not Important”, “Completed”, and “Handle Later”. User also taps feedback controls on summaries such as “More concise”, “More detailed”, and “Hard to understand”.

Terminal records these actions as structured events containing identifiers, timestamps, and labels, and sends them to server. By capturing granular feedback rather than only coarse preference settings, the system acquires richer training data for subsequent model and prompt template updates.

### 10. Model Learning and Prompt Template Adaptation

Server periodically launches a training job that operates over stored message data, emotion information, stress levels, operation history, and feedback. Server constructs training examples for:
urgency/importance prediction: input features are message features and sentence representations; labels are derived from user importance ratings and response times;
stress estimation: input features are aggregated operation history and work data; labels are derived from approximated stress states;
prompt performance: input features are prompt templates and outcome scores; labels are derived from feedback regarding clarity and conciseness.

Server trains or fine-tunes models using gradient-based optimization. Server uses a validation set and early stopping criteria to avoid overfitting. Server may adjust learning rates and regularization parameters according to validation performance.

Server also updates prompt sentence templates by analyzing patterns in feedback. For example, if many users label explanations as “too long”, server modifies templates to include instructions such as “limit the explanation to 3 sentences” or “keep the total length under 150 characters”. Server stores updated templates in configuration structures and uses them in subsequent generative AI model calls.

By jointly updating predictive models and prompt templates, server improves the accuracy and efficiency of the end-to-end pipeline. The system thereby achieves a technical effect of reducing false positives and false negatives in notification decisions, and producing more compact, targeted generated texts that reduce data transfer and rendering overhead.

### 11. Alternative Embodiments and Variations

Server may implement alternative neural architectures for urgency, importance, and stress estimation. For example, server may use:
a gradient boosting machine for tabular features,
a recurrent neural network that encodes sequences of messages or interactions over time,
a multi-task learning architecture that shares a common encoder for both urgency and importance and has separate output heads.

Server may deploy the generative AI model either as a remote service or as an on-premise model. In the on-premise case, server may use model quantization and pruning techniques to reduce model size and accelerate inference. Server may run inference on specialized accelerators such as graphics processing units to further improve throughput.

Server may implement different strategies for associating emotion and stress information with specific users or roles. For example, server may maintain per-user profiles, per-team aggregates, or both, and may adjust notification policies according to group-level states. Terminal may run on different device types, such as handheld scanners in a warehouse or fixed terminals in a control room. In some embodiments, terminal may display colored indicators or use haptic feedback depending on notification type, further customizing information delivery.

Because the described system implements specific data structures for normalized messages, feature vectors, emotion information, stress levels, and notification policies; and because server executes concrete algorithmic steps involving neural networks, training loops, feature extraction, and adaptive prompt design, the system improves the functioning of the computer itself. The system reduces computational and communication overhead by avoiding unnecessary notifications, improves processing accuracy using learned models and feedback loops, and enhances user-interface responsiveness and clarity through automatically tailored content, which cannot be achieved by mere manual triage or simple rule-based filtering.

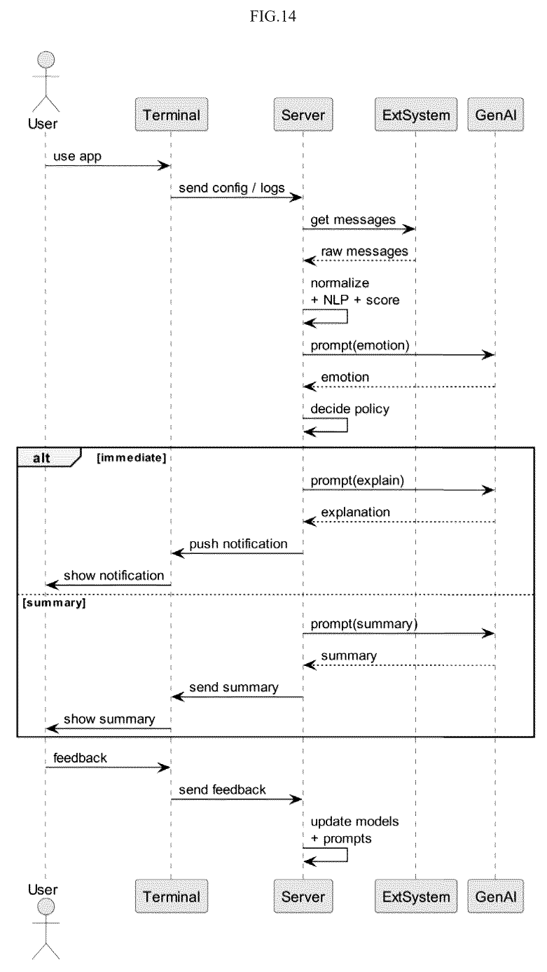

The following describes the processing flow using FIG. 14.

### Step 1:

Server acquires and normalizes messages from external systems.

Input: connection configuration (API endpoints, credentials, polling interval) and raw responses from external information processing apparatuses.

Server reads configuration records from its storage, opens HTTPS connections to each external apparatus, and sends API requests specifying conditions such as “messages created after last_sync_time” and target channels or users.

Server receives heterogeneous message payloads (for example, JSON objects or XML documents) that contain sender, receiver, timestamp, body text, and system-specific metadata. Server parses each payload, extracts fields such as sender_id, receiver_id, timestamp, text, and channel, converts timestamps to a standard time format, and maps the data into an internal common schema.

Server generates a unique message_id for each record and writes the normalized message records into a message table in its database.

Output: normalized message records stored in the server database, each including message_id, source_system, sender_id, receiver_id, timestamp, text, channel, and metadata.

### Step 2:

Server performs tokenization and feature extraction on normalized messages.

Input: normalized message records from the message table.

Server selects records whose processing status is “NEW” and reads their text fields.

Server passes each message text to a morphological analyzer, which segments the text into tokens and assigns part-of-speech tags.

Server identifies domain-specific keywords by comparing tokens to a stored keyword list, counts occurrences and co-occurrences, and computes numerical features such as keyword frequency, message length, and punctuation counts.

Server stores token lists and derived numeric features in a feature table linked to message_id.

Output: tokenized text and primary feature vectors for each message, persisted in the feature table.

### Step 3:

Server generates sentence representations and computes urgency and importance scores.

Input: tokenized text and primary feature vectors from Step 2.

Server loads a pre-trained language representation model into memory and encodes each message text into a fixed-length sentence vector.

Server concatenates the sentence vector with the numeric features (keyword frequencies, length metrics) to form a combined feature vector for each message.

Server inputs each combined vector into a trained prediction model (for example, a neural network) that outputs numerical urgency and importance scores.

Server writes these scores into the message table, updating the urgency and importance fields and setting the processing status to “SCORED”.

Output: updated message records with urgency_score and importance_score.

### Step 4:

Server constructs prompt sentences and calls the generative AI model for emotion estimation. Input: scored message records (text, urgency, importance) and optional contextual information (previous messages in the same thread).

Server selects messages without emotion information, retrieves their text and context, and fills a prompt template with these values.

Server generates a prompt sentence such as:
“Read the following Japanese business message and estimate the sender's emotional state. Output JSON with keys ‘anger’, ‘anxiety’, ‘urgency’, ‘confusion’, ‘fatigue’, and ‘normal’, each from 0 to 5.

Message: “Urgent: Please ship 50 cases of Product A by 5:00 PM today. The customer has already filed a complaint.”

Server sends the prompt sentence to a generative AI model via an API request and receives response text describing emotion categories and numeric scores.

Server parses the response to extract emotion scores per category, converts them into numeric values, and stores them in an emotion table associated with the corresponding message_id and user identifier.

Output: emotion information (emotion categories and their numeric strengths) linked to each message.

### Step 5:

Terminal records operation history and sends it to server.

Input: user interactions with notifications and summaries on terminal.

Terminal logs events such as notification arrival time, notification open time, view duration, mute or dismiss operations, mis-taps, and scroll behavior.

Terminal batches these logs in a local buffer and periodically transmits the batch to server via

HTTPS as structured event data.

Output: operation history payloads sent from terminal to server.

### Step 6:

Server calculates stress level scores from operation history and work data.

Input: operation history payloads from terminal and work data from external systems.

Server receives event logs, writes them into an operation_log table, and aggregates events per user over a defined time window (for example, last 24 hours).

Server computes aggregate features such as average notification reading time, frequency of muting notifications, misoperation rate, total active work time, and time since last break. Server constructs a feature vector for each user from these aggregates and inputs it into a stress estimation model (for example, a regression neural network).

Server obtains a continuous stress level score for each user and stores the score in a user_emotion table associated with the user_id and timestamp.

Output: per-user stress level scores stored as part of emotion information.

### Step 7:

Server determines a notification policy for each message.

Input: message records with urgency_score and importance_score, emotion information for message sender and receiver, and stress level scores from Step 6.

Server retrieves relevant fields (urgency, importance, emotion, stress) and applies rule-based logic or a policy model to decide how each message should be delivered.

Server evaluates conditions, such as “if urgency and importance are high and stress is low, then immediate notification” or “if urgency is medium and stress is high, then delayed notification”.

Server records the decision as a notification policy structure including notification_type (immediate, delayed, summary-only), recommended time, and verbosity level.

Server updates the message table to store the notification_type and related parameters. Output: notification policy entries linked to each message.

### Step 8:

Server generates immediate notifications with supplementary explanations when needed. Input: messages whose notification_type is immediate or delayed and receiver emotion and stress information.

Server retrieves these messages and constructs basic notification content (title, preview text, metadata).

Server checks receiver's emotion and stress; if confusion or stress exceeds a threshold, server prepares a prompt sentence for a supplementary explanation, for example:

“You are an assistant for logistics workers.

Rewrite the following Japanese instruction so that a new worker can understand it easily. Describe the actions in exactly 3 numbered steps.

Avoid technical terms and keep each sentence short and clear.

Instruction: “Please ship 50 cases of Product A by 5:00 PM today. Pick Product A from Shelf A-12 in Zone A, transport it to the inspection line in Area B, and then attach Label L-01.” Server sends the prompt sentence to the generative AI model, receives a rewritten step-by-step explanation, and validates its format (e.g., presence of three steps and acceptable length). Server appends the validated explanation to the basic notification content and constructs a final notification payload including message_id, title, body, and supplementary explanation. Server transmits this payload to terminal using a push notification or a real-time communication channel.

Output: notification payloads containing tailored content delivered from server to terminal.

### Step 9:

Server generates summaries for messages designated as summary-only.

Input: messages whose notification_type is summary-only and user stress information. Server groups messages by user and by category or time period (for example, “today's low-priority updates”).

Server creates a prompt sentence for each group that instructs the generative AI model to summarize messages in a tone and length appropriate for the user's stress level, for example: “Summarize the following Japanese business messages about today's warehouse operations. The reader is under stress, so use calm and reassuring language.

Extract only the 3 most important points and output them as 3 bullet points in Japanese. Messages:
1. “As a result of the inventory count conducted this afternoon, we found that two cases of Product B are missing.”
2. “Following an inquiry from the shipper, we confirmed one labeling error in yesterday's shipment.”
3. “We will hold an orientation session tomorrow morning to explain the new picking rules.” Server sends the prompt sentence and concatenated message texts to the generative AI model, receives the summary text, and checks format constraints (for example, number of bullet points).

Server stores the summary text in a summaries table, associated with user id, date, and category, for later retrieval by terminal.

Output: summary records ready to be displayed to the user as later-view summaries.

### Step 10:

Terminal displays notifications and summaries and records user feedback.

Input: notification payloads and summary records received from server.

Terminal receives push notifications, displays titles and preview snippets using the platform's notification interface, and opens detailed views showing the full content and supplementary explanations when user taps them.

Terminal fetches summary records (for example, when user opens a “Daily Summary” screen) and renders them as lists or cards.

User reads the content and interacts with controls on terminal such as “Mark as Important”, “Not Important”, “Completed”, “Handle Later”, “More concise”, or “More detailed”. Terminal records these interactions as feedback events including user_id, message_id or summary_id, timestamp, and selected labels, and transmits feedback events back to server. Output: feedback event payloads containing explicit user evaluations and actions.

### Step 11:

Server updates models and prompt templates based on aggregated feedback.

Input: feedback event payloads, message records, emotion information, urgency and importance scores, and stress levels.

Server joins feedback events with corresponding messages and emotion data to construct training datasets.

Server uses these datasets to retrain or fine-tune the urgency/importance prediction model and the stress estimation model, adjusting parameters to reduce prediction error according to a defined loss function.

Server analyzes feedback regarding explanatory text and summaries; for example, frequent “More concise” selections cause server to modify prompt templates to request shorter outputs, while frequent “Hard to understand” selections cause server to instruct the generative AI model to use simpler language and concrete examples.

Server updates stored prompt sentence templates accordingly and reloads the updated templates into memory for subsequent use in Steps 4, 8, and 9.

Output: updated prediction models and refined prompt sentence templates that improve future message scoring, emotion estimation, notification behavior, and generated text quality.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

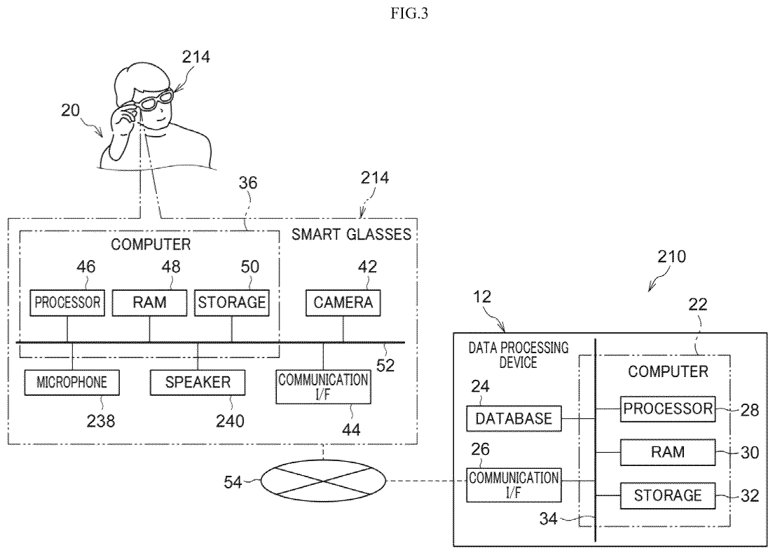

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

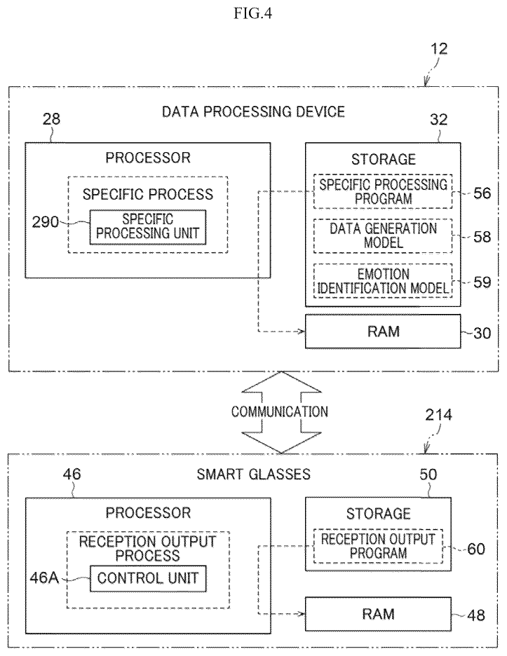

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

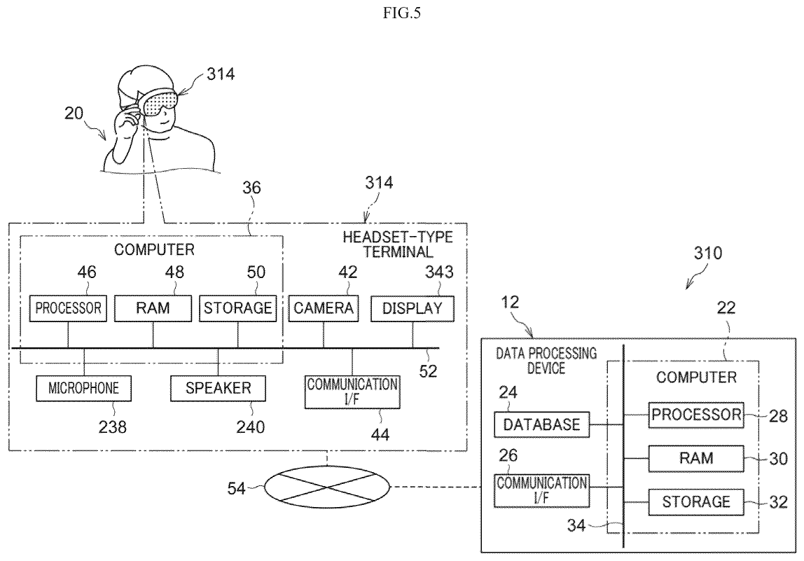

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

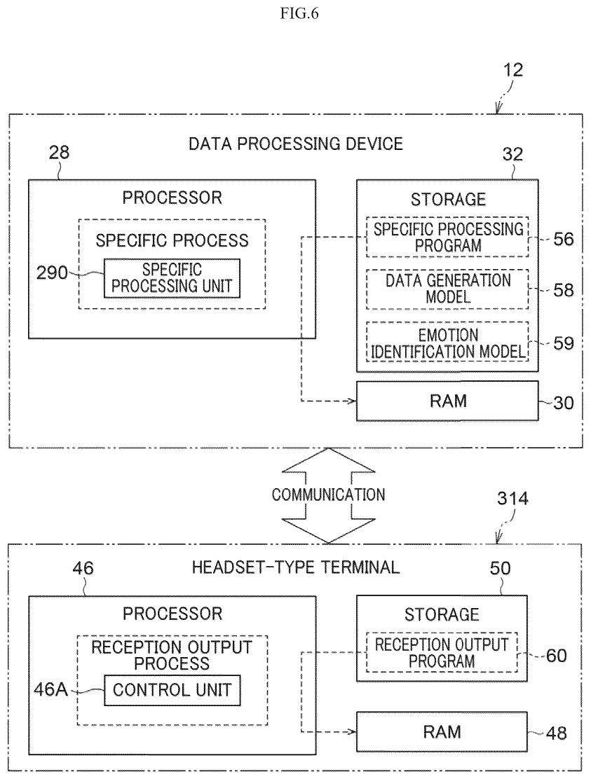

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

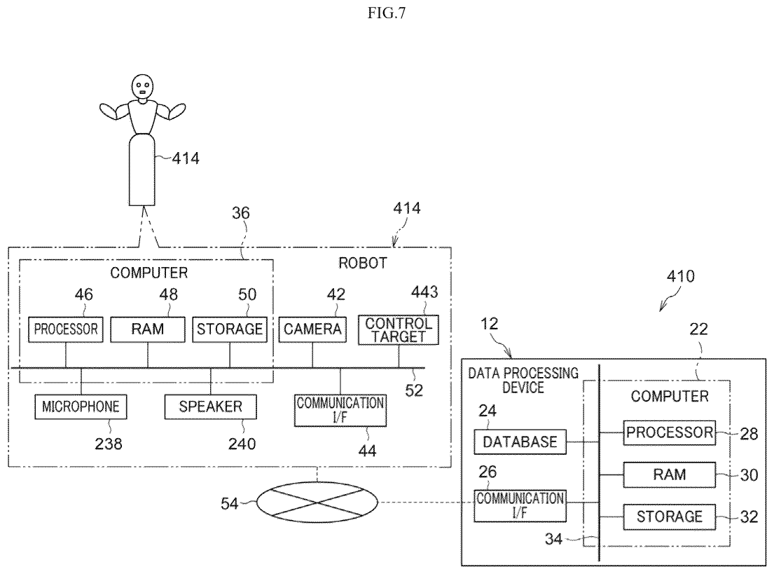

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

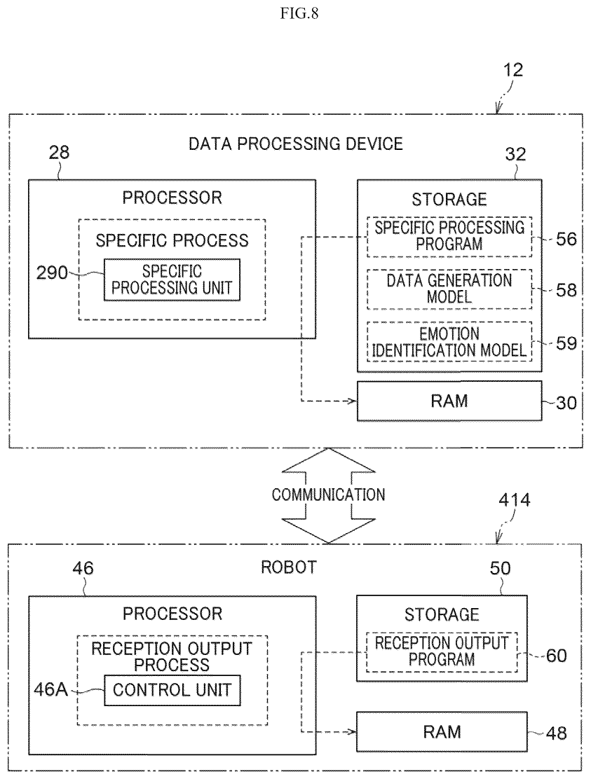

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

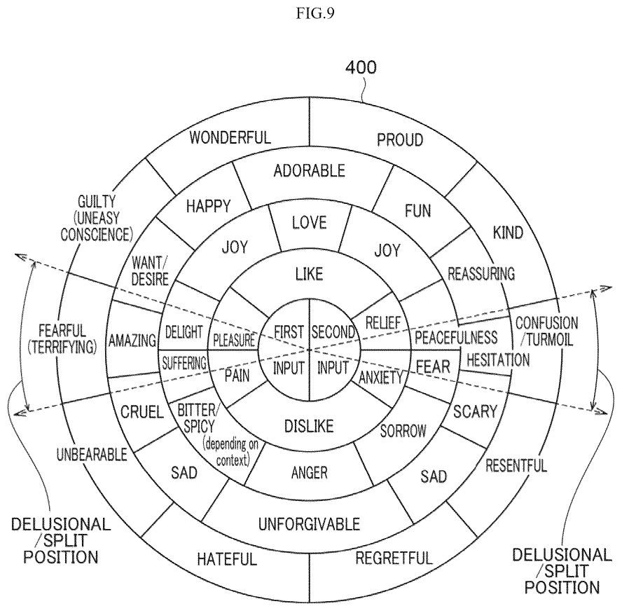

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

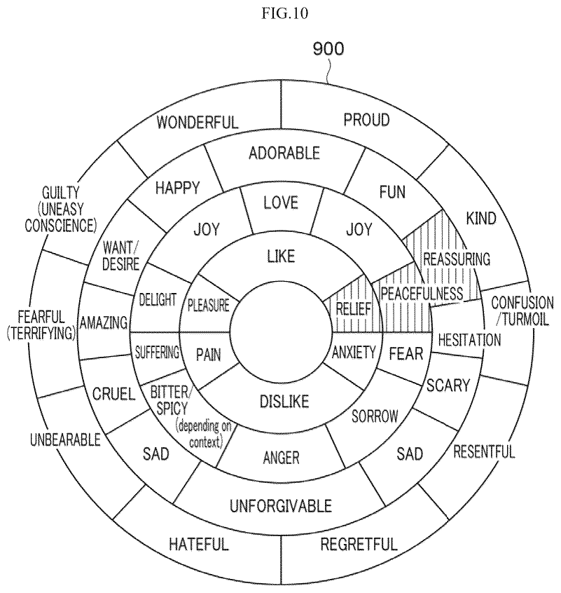

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to implement a message acquisition unit operating on a plurality of types of information processing devices, a natural language processing unit that performs natural language analysis on messages acquired by the message acquisition unit, a notification generation unit that generates notification information based on messages evaluated as high priority by the natural language processing unit, and a summary generation unit that generates summary information based on messages evaluated as low priority by the natural language processing unit,
wherein the processor is configured to preprocess text of each message by normalizing character encoding, removing structured document data, and deleting text of past message threads,
wherein the processor is configured to segment the text of each message and assign morphological information and part-of-speech information,
wherein the processor is configured to extract keywords based on statistical indicators and rules and to detect urgency-related terms and deadline-related terms, wherein the processor is configured to generate analysis input data including attribute information of each message, the keywords, and hint information based on the rules, and to transmit, to a generative AI model, input information including the analysis input data together with a prompt sentence that specifies an output format of at least urgency, importance, and keywords,
wherein the processor is configured to receive, from the generative AI model, response information including at least urgency, importance, and keywords, to extract, from the response information, classification results and feature values in a predefined format, and to convert the classification results and the feature values into numerical scores,
wherein the processor is configured to integrate the numerical scores with estimation results obtained by a classification model learned based on user operation history, to determine final urgency and importance for each message, and to allocate each message to one of a high-priority queue, a normal-priority queue, and a low-priority queue,
wherein the processor is configured, by the notification generation unit, to transmit, to the generative AI model, input information including a prompt sentence that specifies a length and content policy of a notification summary for messages belonging to the high-priority queue, to generate a short summary, to construct a notification payload including at least the short summary, sender information, and priority information, and to transmit the notification payload to a user terminal via an external notification infrastructure,
wherein the processor is configured, by the summary generation unit, to group a plurality of messages belonging to the low-priority queue according to predetermined conditions, to transmit, to the generative AI model, input information including a prompt sentence that specifies extraction of at least decision information, issue information, and deadline information for each group, to generate summary information for each group, and to store and provide the summary information,
and wherein the processor is configured to receive, as the user operation history, at least an opening operation for a notification, an ignoring operation for a notification, a priority change operation, and a setting change operation on a sender basis, and to dynamically change contents of the prompt sentence for the natural language processing unit and the generative AI model in accordance with the user operation history.

### (Supplementary 2)

The system according to supplementary 1,
wherein the processor is configured, in the message acquisition unit, to acquire message data periodically or sequentially via communication interfaces of a plurality of types of information exchange services using at least an electronic mail communication protocol, a request-response communication protocol, and a bidirectional persistent-connection communication protocol, and to convert the message data into a unified internal representation and store the unified internal representation,
wherein the processor is configured, in the notification generation unit, to perform notification via a notification function provided by an operating system of the user terminal, the notification including at least one of popup display, sound output, and vibration output, and to control presence or absence of the notification and intensity of the notification based on time-zone settings and word conditions obtained from the user terminal,
and wherein the processor is configured, in the summary generation unit, to store the summary information on a time basis or a category basis and to provide the summary information via a display-information distribution function and an electronic mail transmission function.

### (Supplementary 3)

The system according to supplementary 1,
wherein the processor is configured, in the natural language processing unit, to update the classification model by using training data including the user operation history and by using at least one of a statistical learning method and a neural network, to thereby improve estimation accuracy of the urgency and the importance of the messages,
and wherein the processor is configured to include, in the prompt sentence transmitted to the generative AI model, example information of messages judged as important by the user and sender attribute information, to reflect a user-specific importance determination criterion in the generative AI model, and to adapt output results of the urgency and the importance obtained from the generative AI model for each user.

### Application Example 1

### (Supplementary 1)

A system comprising a processor,
wherein the processor is configured to function as a message acquisition unit that acquires message data from a plurality of different communication applications, stores the acquired message data in a storage device in a normalized common format, and maintains, for each message, attribute information including at least a source type, a reception time, and text data, wherein the processor is configured to function as a natural language processing unit that performs natural language processing on the text data included in the message data, the natural language processing unit being configured to generate, from the message data, analysis target data including the text data and a prompt sentence indicating a processing content of evaluating urgency and importance of the message and extracting keywords, to input the analysis target data to a generative AI model, and to obtain, from the generative AI model, analysis result data including at least an urgency of the message, an importance of the message, and one or more keywords,
wherein the processor is configured to function as a notification generation unit that, based on the urgency and the importance included in the analysis result data, generates notification information for messages having at least a predetermined urgency and a predetermined importance, converts the notification information into a format corresponding to an output channel of an information output device, and transmits the notification information to the information output device so that real-time notification is performed to a user,
wherein the processor is configured to function as a summary generation unit that, for a plurality of messages evaluated as having lower urgency and lower importance, generates summary information that allows the user to check the messages later, by generating input data including text data of the plurality of messages and a prompt sentence indicating a processing content of summarization and extraction of important points, inputting the input data to the generative AI model, and obtaining, from the generative AI model, summary result data in which the plurality of messages are integrated and summarized,
wherein the processor is configured to compute, based on the analysis result data and the summary result data as message attribute information, and based on operation history information and setting information acquired from the user, a priority for each message, to perform real-time notification for messages having a priority equal to or higher than a predetermined threshold, and to provide, for messages having a priority lower than the predetermined threshold, aggregated summary information in accordance with a temporal sequence, and
wherein the processor is configured to change contents of the prompt sentence for the generative AI model based on feedback information acquired from the user so as to dynamically adjust at least an output format of urgency evaluation, importance evaluation, and summary result.

### (Supplementary 2)

The system according to supplementary 1,
wherein the processor is configured to cause the message acquisition unit to acquire the message data periodically or event-driven via communication interfaces provided by a plurality of types of information processing services including at least an electronic mail service, an interactive communication service, and a business management service, and to normalize the acquired message data into the common format and store the normalized message data in the storage device,
wherein the processor is configured to cause the natural language processing unit to extract unstructured text data from the message data, to perform preprocessing including removal of unnecessary information and tokenization on the unstructured text data, and to automatically generate the prompt sentence for input to the generative AI model based on the preprocessed text data,
wherein the processor is configured to cause the notification generation unit to convert notification data relating to a message having a high priority into a format corresponding to a notification channel of a portable information terminal or a display device and to output the notification data as popup display or visually emphasized display on the portable information terminal or the display device, and
wherein the processor is configured to cause the summary generation unit to group, based on at least a work type or a related term, messages having a low priority acquired within a predetermined period, to input grouped message text data and a corresponding prompt sentence to the generative AI model, and to generate, for each group, summary information including a summary and recommended responsive actions and to display, via a user interface, a list of the summary information.

### (Supplementary 3)

The system according to supplementary 1,
wherein the processor is configured to cause the natural language processing unit to generate feature data based on the analysis result data obtained from the generative AI model and the feedback information from the user, and to update a statistical learning model using the feature data so as to sequentially improve evaluation accuracy of the urgency and the importance of the messages,
wherein the processor is configured to cause the notification generation unit to perform notification control based on user settings that allow change of at least a type of the information output device to be notified, a notification timing, and a degree of simplification of notification contents, in accordance with a priority score computed by the statistical learning model, and
wherein the processor is configured to cause the summary generation unit to change constraint conditions of the prompt sentence in accordance with at least a work area, a period, and a detail level specified by the user, and to adjust an amount and granularity of information included in the summary output.

### Example 2

### (Supplementary 1)

A system comprising a processor,
wherein the processor is configured to
acquire, from a plurality of information communication services, electronic messages, and store the acquired electronic messages as message records in a unified format, and perform natural language processing on body data of the electronic messages, the natural language processing including morphological analysis and statistical text analysis, thereby extracting word sequences, feature terms, and match information with an importance dictionary, and calculating basic indices related to urgency and importance of the electronic messages, and
generate a prompt sentence for a generative AI model based on an analysis result obtained by the natural language processing and the body data of each electronic message, transmit the prompt sentence to a generative AI model arranged externally or internally, obtain a response including a score related to the urgency and the importance of the electronic message and at least one of a keyword and summary text, parse the response, and store the parsed response in association with the electronic message as analysis information, and
acquire notification history and operation history transmitted from a user terminal, calculate, based on the notification history and the operation history, feature values including notification opening time, non-opening rate, deletion rate, and time zone information, estimate a state label indicating an emotional state or psychological state of a user by using a machine learning model and, when necessary, the generative AI model, and store the state label as user state information, and
calculate, based on the score related to the urgency and the importance obtained from the generative AI model, the feature values related to psychological load obtained by the natural language processing, the estimated emotional state of the user, and a notification policy for each user, a composite priority for each electronic message, and classify the electronic message into at least one of an immediate notification target, a delayed notification target, and a summary target, and
generate, for an electronic message classified as the immediate notification target or the delayed notification target, notification information by determining notification content according to the emotional state of the user and the notification policy, including, when necessary, generating a prompt sentence for the generative AI model to generate a short summary sentence in a neutral tone that reduces psychological pressure, obtaining a summary result from the generative AI model, and using at least one of the summary result and a partial original text as notification content, and outputting the notification information to the user terminal, and
generate, for a plurality of electronic messages classified as the summary target, summary information by aggregating the plurality of electronic messages based on a predetermined period or condition, generating a summary prompt sentence for input to the generative AI model including body data and sender information of the plurality of electronic messages, obtaining, from the generative AI model, summary text organized by topic, and providing the summary information in a form that is referable by the user at a later time.

### (Supplementary 2)

The system according to supplementary 1,
wherein the processor is configured to
acquire message data periodically or sequentially from the information communication services by using at least one of a message reception protocol and an application programming interface, tokenize text of the message data and perform keyword extraction and context analysis in the natural language processing to generate feature values used for evaluation of the urgency and the importance of the message data, execute notification by causing a notification function of an information processing terminal of the user to perform at least one of popup display, status display, and audio output based on the notification information, and provide the summary information to the user as at least one of dashboard information and an electronic message.

### (Supplementary 3)

The system according to supplementary 1,
wherein the processor is configured to
generate, based on past message evaluation results, notification history, and feedback information for each user, a policy prompt sentence for obtaining an adjustment proposal for the notification policy from the generative AI model, obtain, from the generative AI model, proposal information related to the notification policy including at least a maximum number of notifications per unit time, permission or prohibition of notifications in a specific time zone, and threshold values for distinguishing between the immediate notification target and the summary target, parse the proposal information, update the notification policy for each user based on the parsed proposal information, and perform message classification and composite priority calculation based on the updated notification policy.

### Application Example 2

### (Supplementary 1)

A system comprising a processor,
wherein the processor is configured to acquire, from a plurality of external information processing apparatuses, business-related messages and convert the acquired messages into an internal common format and store the converted messages as normalized message data, wherein the processor is configured to perform natural language processing on character information included in the messages, and evaluate an urgency and an importance of each message as numerical values based on morphological analysis, syntactic analysis, and semantic analysis of the messages,
wherein the processor is configured to generate a prompt sentence including the character information of each message and related context information, input the prompt sentence to a generative AI model, estimate an emotional state of a sender or a receiver of the message based on an output of the generative AI model, and generate emotion information including an emotion category and a strength of the emotion category,
wherein the processor is configured to estimate a stress level of the receiver based on the emotion information and operation history information or work status information of the receiver, and determine a notification policy for each message based on at least the urgency, the importance, the emotion information, and the stress level, the notification policy including whether the message is to be presented as an immediate notification or as a later-view summary, and control a presence or absence, a timing, a content, and an expression format of a notification dynamically according to the notification policy,
wherein the processor is configured, in accordance with the notification policy, to generate, for a message determined to be an immediate presentation target, notification information including a basic notification content and a supplementary explanation, by generating a prompt sentence according to the emotional state or the stress level of the receiver, inputting the prompt sentence to the generative AI model, obtaining the supplementary explanation from the generative AI model, and combining the supplementary explanation with the basic notification content, and to transmit the notification information to an information presentation apparatus,
wherein the processor is configured, for a plurality of messages that are not determined to be immediate presentation targets by the notification policy, to perform grouping and summarization processing based on at least the urgency, the importance, and the emotion information, generate a prompt sentence that takes into account a psychological burden of a user, input the prompt sentence and the grouped messages to the generative AI model, obtain summary information from the generative AI model, and provide the summary information for later viewing through the information presentation apparatus, and
wherein the processor is configured to collect, from the information presentation apparatus, operation history information and feedback information of a user regarding the notification information and the summary information, associate the operation history information and the feedback information with the messages and the emotion information to generate training data, update at least one of a model for evaluating the urgency and the importance by the natural language processing and a model for estimating the emotional state by the generative AI model, and improve templates of the prompt sentences to be input to the generative AI model based on the training data.

### (Supplementary 2)

The system according to supplementary 1,
wherein the processor is configured to periodically call connection interfaces provided by the plurality of external information processing apparatuses, acquire new messages, extract sender identification information, receiver identification information, transmission time information, message body text, and channel information from each acquired message, and map the extracted information to a common schema as the internal common format,
wherein the processor is configured to tokenize the message body text, count occurrences and combinations of domain-specific keywords, input the message body text to a pre-trained language representation model to obtain a sentence vector, and input the sentence vector and features derived from the domain-specific keywords to a prediction model to output the urgency and the importance as scores, and
wherein the processor is configured, in generating the summary information, to group messages selected by the notification policy by category, and generate a prompt sentence including instructions to change at least one of a length and a tone of the summary according to the stress level of the user, and input the prompt sentence to the generative AI model.

### (Supplementary 3)

The system according to supplementary 1,
wherein the processor is configured to input, to a machine learning model, as features, at least the character information of the messages, the operation history information including at least notification viewing time, notification mute frequency, misoperation count, and screen transition pattern on the information presentation apparatus, and work data including at least working time information and break acquisition status, calculate the stress level score for each receiver as part of the emotion information, and manage the stress level score in association with the receiver, and
wherein the processor is configured, based on at least importance evaluations by the user for the notification information or the summary information, completion times of responses to the messages, and feedback regarding comprehensibility of explanations or summaries, to update parameters of the prediction model and the machine learning model and to update constraint conditions of the prompt sentences, and apply updated prompt sentences to subsequent notification generation and summary generation.

What is claimed is:

1. A system comprising:
circuitry configured to:
acquire, via a plurality of communication interfaces operating over a packet-switched network, data records from a plurality of heterogeneous information exchange services;
perform natural language processing on text data of each data record, the natural language processing comprising tokenization, extraction of feature terms based on term frequency-inverse document frequency computation, and detection of rule-based keyword features;
generate, for each data record, structured analysis input data comprising the feature terms and hint information derived from the rule-based keyword features;
transmit, to a generative artificial intelligence model, input information comprising the structured analysis input data together with a prompt sentence that specifies an output format for at least an urgency classification, an importance classification, and one or more extracted keywords;
receive, from the generative artificial intelligence model, response information comprising the urgency classification, the importance classification, and the one or more extracted keywords;
convert the urgency classification and the importance classification into numerical scores and integrate the numerical scores with output of a classification model that is trained using operation history data;
allocate each data record to one of a plurality of priority queues based on the integrated numerical scores; and
generate, for data records allocated to a first priority queue, output data comprising a condensed text representation produced by the generative artificial intelligence model in accordance with a task-specific prompt sentence, and transmit the output data to a client terminal via the packet-switched network.

2. The system according to claim 1, wherein the plurality of heterogeneous information exchange services comprise at least an electronic mail service, an interactive text-based communication service, and a business management service.

3. The system according to claim 1, wherein the circuitry is further configured to acquire the data records by connecting to the electronic mail service using an internet message access protocol, connecting to the interactive text-based communication service using a request-response protocol over a secure transport layer, and connecting to a real-time communication service using a bidirectional persistent-connection protocol.

4. The system according to claim 1, wherein the circuitry is further configured to perform text normalization on the text data of each data record prior to the tokenization, the text normalization comprising decoding character encodings into a standardized encoding, removing markup elements, and deleting redundant thread content using pattern-based rules.

5. The system according to claim 1, wherein the structured analysis input data further comprises attribute information of each data record, the attribute information including at least a sender category, a data record length, a number of recipients, and a historical interaction metric associated with a sender.

6. The system according to claim 1, wherein the prompt sentence transmitted to the generative artificial intelligence model further includes one or more example data records with associated classification labels as few-shot examples to guide the urgency classification and the importance classification.

7. The system according to claim 1, wherein the classification model comprises a gradient boosting decision tree model trained on feature vectors derived from the feature terms, sender attributes, and the rule-based keyword features, with labels representing urgency and importance levels determined from the operation history data.

8. The system according to claim 1, wherein the classification model comprises a neural network classifier having a multi-layer perceptron with rectified linear activation functions, the neural network classifier being trained to output urgency scores and importance scores.

9. The system according to claim 1, wherein the circuitry is further configured to update parameters of the classification model by performing gradient-based optimization on batches of training examples derived from the operation history data, the gradient-based optimization comprising an adaptive moment estimation algorithm.

10. The system according to claim 1, wherein the circuitry is further configured to modify contents of the prompt sentence based on patterns identified in the operation history data, the modification comprising adding contextual instructions that reflect user-specific classification preferences associated with particular senders.

11. The system according to claim 1, wherein the plurality of priority queues comprise a high-priority queue, a normal-priority queue, and a low-priority queue, and wherein the circuitry allocates each data record to one of the high-priority queue, the normal-priority queue, and the low-priority queue by comparing the integrated numerical scores against configurable threshold values.

12. The system according to claim 1, wherein the task-specific prompt sentence for generating the condensed text representation specifies a maximum character count and instructs the generative artificial intelligence model to highlight a main issue and urgency of the data record.

13. The system according to claim 1, wherein the circuitry is further configured to group data records allocated to a second priority queue according to time-based or category-based conditions, to transmit to the generative artificial intelligence model a summarization-oriented prompt sentence that specifies extraction of decision information, issue information, and deadline information, and to store summary information received from the generative artificial intelligence model in association with the grouped data records.

14. The system according to claim 1, wherein the circuitry is further configured to receive, from the client terminal, feedback data indicating at least one of an opening operation, an ignoring operation, a priority change operation, and a setting change operation, and to record the feedback data as the operation history data for updating the classification model.

15. The system according to claim 1, wherein the generative artificial intelligence model comprises a transformer-based neural network having a plurality of self-attention layers and feed-forward sublayers with learned parameters.

16. The system according to claim 1, wherein the circuitry is further configured to estimate an emotional state of a user associated with the client terminal by computing feature values from notification history and operation history received from the client terminal, inputting the feature values to a machine learning model trained to classify emotional states, and adjusting a composite priority calculation for each data record based on the estimated emotional state.

17. The system according to claim 16, wherein the feature values comprise at least an average notification opening delay, a non-opening rate, a quick deletion rate, and a frequency of setting a do-not-disturb mode, and wherein the machine learning model comprises a feed-forward neural network with a softmax output layer that outputs probability scores for emotional state labels.

18. A system comprising:
circuitry configured to:
acquire, via a plurality of communication interfaces operating over a packet-switched network using at least an internet message access protocol, a request-response protocol over a secure transport layer, and a bidirectional persistent-connection protocol, data records from a plurality of heterogeneous information exchange services, and convert the data records into a normalized common format;
perform text normalization on text data of each data record by decoding character encodings into a standardized encoding, removing markup elements using a parser, and deleting redundant thread content using pattern-based rules;
tokenize the normalized text data using a language-specific tokenizer to produce token sequences with associated morphological information and part-of-speech information;
compute term frequency-inverse document frequency values for each token across a sliding window of data records, select feature terms having term frequency-inverse document frequency values exceeding a predetermined threshold, and detect rule-based keyword features by evaluating regular expression patterns against the token sequences to identify urgency-related terms and deadline-related terms;
generate, for each data record, structured analysis input data comprising attribute information, the feature terms, and hint information derived from the rule-based keyword features;
transmit, to a generative artificial intelligence model comprising a transformer-based neural network having a plurality of self-attention layers and feed-forward sublayers, input information comprising the structured analysis input data together with a prompt sentence that specifies an output format for at least an urgency classification, an importance classification, and one or more extracted keywords, the prompt sentence further including one or more example data records with associated classification labels;
receive, from the generative artificial intelligence model, response information, and parse the response information using deterministic parsing rules to extract the urgency classification, the importance classification, and the one or more extracted keywords;
convert the urgency classification and the importance classification into numerical scores, input feature vectors derived from the feature terms and sender attributes into a classification model trained using operation history data, and integrate the numerical scores from the generative artificial intelligence model with output scores from the classification model using a weighted aggregation rule;
allocate each data record to one of a high-priority queue, a normal-priority queue, and a low-priority queue based on the integrated scores and configurable threshold values;
generate, for data records allocated to the high-priority queue, output data comprising a condensed text representation produced by the generative artificial intelligence model in accordance with a notification-specific prompt sentence that specifies a maximum character count, and transmit the output data to a client terminal via the packet-switched network; and
group data records allocated to the low-priority queue according to time-based or category-based conditions, transmit to the generative artificial intelligence model a summarization-oriented prompt sentence that specifies extraction of decision information, issue information, and deadline information, and store summary information received from the generative artificial intelligence model for subsequent retrieval by the client terminal.

19. The system according to claim 18, wherein the circuitry is further configured to modify contents of the prompt sentence dynamically based on patterns identified in operation history data received from the client terminal, the modification comprising adding contextual instructions that reflect user-specific classification preferences associated with particular senders, and to periodically retrain the classification model by performing gradient-based optimization on training examples derived from the operation history data.

20. A method performed by circuitry of a system, the method comprising:
acquiring, via a plurality of communication interfaces operating over a packet-switched network, data records from a plurality of heterogeneous information exchange services;
performing natural language processing on text data of each data record, the natural language processing comprising tokenization, extraction of feature terms based on term frequency-inverse document frequency computation, and detection of rule-based keyword features;
generating, for each data record, structured analysis input data comprising the feature terms and hint information derived from the rule-based keyword features;
transmitting, to a generative artificial intelligence model, input information comprising the structured analysis input data together with a prompt sentence that specifies an output format for at least an urgency classification, an importance classification, and one or more extracted keywords;
receiving, from the generative artificial intelligence model, response information comprising the urgency classification, the importance classification, and the one or more extracted keywords;
converting the urgency classification and the importance classification into numerical scores and integrating the numerical scores with output of a classification model that is trained using operation history data;
allocating each data record to one of a plurality of priority queues based on the integrated numerical scores; and
generating, for data records allocated to a first priority queue, output data comprising a condensed text representation produced by the generative artificial intelligence model in accordance with a task-specific prompt sentence, and transmitting the output data to a client terminal via the packet-switched network.
